(19) United States
(12) Patent Application Publication
(10) Pub. No.: US 2015/0240440 A1
(43) Pub. Date: Aug. 27, 2015

(54) Methods and Connectors for Making Structural Connections Without Offshore Welding of Connectors

(71) Applicant: GMC Ltd., Aberdeen (GB)

(72) Inventors: Robert Johns, Aberdeen (GB); Edward J. Arlt, Aberdeen (GB); Alpha Mahatvaraj, Aberdeen (GB); David Riggs, Aberdeen (GB)

(21) Appl. No.: 14/424,659

(22) PCT Filed: Aug. 30, 2013
(86) PCT No.: PCT/US2013/057625

§ 371 Date: Feb. 27, 2015

Related U.S. Application Data
(60) Provisional application No. 61/791,389, filed on Mar. 15, 2013.
(60) Provisional application No. 61/702,123, filed on Sep. 17, 2012.
(60) Provisional application No. 61/702,143, filed on Sep. 17, 2012.
(60) Provisional application No. 61/695,785, filed on Aug. 31, 2012.

(51) Int. Cl. E02B 17/02; F16B 7/02

(52) U.S. Cl. CPC E02B 17/02; F16B 7/02

(57) ABSTRACT

Systems and methods that permit assembly, disassembly, and relocation of modular structures, such as platforms and towers, without the need for permanent attachment of the modules, such as welding. Aspects of certain embodiments replace permanent attachment means, such as welding, with connectors at the structural interfaces between modules. Certain embodiments of the connectors of the present invention allow for the repeated reuse and relocation of modular structures as needed. Certain embodiments allow for the use of float-over methodologies to coupled topside modules to supporting structures without offshore welding.

### CROSS-REFERENCE TO RELATED APPLICATIONS

This application claims priority to U.S. Provisional Patent Applications (1) No. 61/695,785, filed Aug. 31, 2012; (2) No. 61/702,123, filed Sep. 17, 2012; (3) No. 61/702,143, filed Sep. 17, 2012; and (4) No. 61/791,389, filed Mar. 15, 2013, all four of which are incorporated by reference in their entireties.

### BACKGROUND

1. Field of the Invention

Embodiments of the present invention relate generally to modular structures, particularly modular platforms that are reusable and reconfigurable, and methods of assembling same using a connector to couple the modules of the structures.

2. Description of Related Art

Free standing offshore structures are usually deployed in modules which are stacked in sequence from the seabed upward. The bottom most module is normally a foundation template, a concrete gravity base, or a jacket. These are secured and leveled at the seabed using any one of several methods including driven piles and suction piles. All subsequent modules in the structural stack sequence are secured with various welding technologies, whether the interface is above the water line or below it. The biggest drawback to this approach is that offshore welding is extremely slow and expensive. In addition, such welded structures must be salvaged by destructive cutting (and sometimes by explosives) when their purpose at their original site has been fulfilled.

A common method of creating offshore structures is to fabricate modules at an on-shore construction yard, transport them to the installation site by barges or other vessels, and then deploy them to the seabed in whatever sequence is necessary to complete the structure. Typically, for free standing platforms resting on the seabed, the initial module or “jacket” will extend from the seabed to an elevation above the water line. The jacket structure is normally fixed to the seabed with piles driven deep into the seabed and then leveled by jacking the jacket corners up or down on those piles. Once leveled and grouted onto the piles, the top side deck modules (typically with processing equipment already installed) are added to the top of the jacket. There may be any number of these extending vertically as well as horizontally. All of this assembly work is accomplished via standard welding technology.

Installation of very large and heavy top sides structures to free standing fixed platforms and to floating platforms is often done by floating the top sides structure over the platform and then manipulating buoyancy in order to mate one with the other. During the mating procedure, elastomeric loaded canisters may be employed to facilitate alignment of the structures being mated and mitigate impact loads due to wave and swell driven dynamics. These units are typically referred to as Deck Mating Units and Leg Mating Units.

Once mated, the multiple interfaces between the top sides module and the supporting structure must be secured in place while the interfaces are completed by welding.

In some instances where the platform is being installed in deeper waters, the base jacket does not extend above the water line and subsequent module(s) must be installed starting at the underwater interface with the base jacket module. In such instances, welding by divers (or even remotely operated vehicles (ROVs)) is employed to complete the structural interface.

When these structures have fulfilled their purpose at a particular site or lived out their useful lives, they cannot be picked up and moved or disassembled. Instead they have to be cut apart (either by torches or explosives) and the components transported back to shore for scrap salvage.

The structural joining methodologies currently employed in offshore construction are costly, excruciatingly slow, labor intensive, and fraught with opportunities for errors and delays. Not only welding operations, but also Non-Destructive Examination procedures (or testing welds) are also hard to execute in the offshore environment and even more so when done below the surface. In addition to that, structures that are permanently assembled via welding do not allow for those structures to be reused or relocated to form another platform. After the platform has been installed at one site and taken apart once done, it is typically relegated to scrap.

### SUMMARY

In response to the deficiencies in the current technology as described above, certain of the present embodiments have modules that permit assembly, disassembly, and relocation of modular structures, such as platforms and towers, without the need for permanent attachment of the modules, such as through welding. For example, such embodiments can include float-over methodology for mating top side modules to platforms. Aspects of certain embodiments of the present invention replace permanent attachment means, such as welding, with connectors at the structural interfaces between modules. Certain embodiments of the connectors of the present invention allow for the repeated reuse and relocation of such platforms, towers and other structures, as needed. Other aspects of the present disclosure allow the modular platform or tower or other structure of the present disclosure to be reconfigured (using differing combinations of modules to accommodate specific conditions) for each installation site. Other aspects of the present embodiments (using reversible connectors), may also be used to install peripheral packages (e.g., compressor sets, processing modules, and the like) onto the top sides structure once it has been installed. Importantly, embodiments of the present connectors can be configured to be self-aligning and meeting or exceeding the full strength properties (in axial tension, bending moment, torsion, and fatigue) of the parent structural tubulars (tubular members).

According to one aspect of the present disclosure, certain embodiments of the modular platform of the present disclosure eliminate the need for structural welding in the field (offshore or otherwise) and allows structures of all sizes to be assembled rapidly in-situ with sufficient structural integrity. The mechanical connection is self-aligning and allows full strength properties (in axial tension, bending moment, torsion, and fatigue) of the parent structural members. Said connector is also reversible and allows disassembly of the platform for subsequent employment elsewhere and for new purposes, if desirable. Due to the modular nature, certain embodiments of the platform of the present disclosure can be configured to accommodate a large range of water depths and installation conditions just by adding and subtracting modules as needed for each new location.

According to another aspect of the present disclosure, certain embodiments of the present disclosure uses a mechanical connector comprising a pin and box with conically shaped arrays of non-helical concentric teeth. The interfacing conical surfaces of the pin and box are preferably lubricated with heavy marine grease prior to make-up. In most instances make-up can be accomplished due to self-weight of the components alone. The box expands mechanically over the pin as they are forced together and the teeth of one slides over the teeth of the other until the pin is fully inserted into the box. At that point, the opposing arrays of teeth interlock as the box snaps back to its original diameter over the OD of the pin.

As stated above, the connector configuration permits disassembly of the structural connection whenever necessary. In order to accomplish break-out, the conical annular space between the pin and the box teeth must be pressurized through a pressure port in the OD of the box. This port provides a means of injecting pressure into the annular cavity and separating the teeth both during break-out operations. Nib seals are provided in the design of both the pin and the box to facilitate the containment of annular pressure. Pressurization of the connector annulus can be accomplished via ROV hot stab panels located on each module and plumbed to each of the box installations.

Embodiments of the present invention provide for systems and methods that permit assembly, disassembly, and relocation of modular structures, such as platforms and towers, without the need for permanent attachment of the modules, such as welding. Aspects of certain embodiments replace permanent attachment means, such as welding, with connectors at the structural interfaces between modules. Certain embodiments of the connectors of the present invention allow for the repeated reuse and relocation of modular structures as needed.

According to one aspect of the present invention, there is provided a connector system comprising: a pin component comprising a plurality of surface features; a box component comprising a plurality of surface features configured to engage with the surface features of the pin component to form an interface between the pin component and the box component; a pressurization component configured to pressurize the interface between the surface features of the pin component and the surface features of the box component.

In one aspect, the surface features of the pin component are disposed on the outer wall of the pin component and the surface features of the box component are disposed on the interior wall of the box component. In another embodiment, the pin component is attached to a first modular component and the box component is attached to a second modular component. In another embodiment, the engagement of the surface features of the pin component and box component attaches the pin component to the box component. In another embodiment, the pressurization of the interface separates the surface features of the pin component from the surface features of the box component. In yet another embodiment, the surface features of the pin component and box component comprise a plurality of teeth.

According to another aspect of the present invention, there is provided a modular structure comprising: a first module comprising a pin component with a plurality of surface features; a second module comprising a box component with a plurality of surface features configured to engage with the surface features of the pin component; wherein engagement of said surface features attach the first module to the second module; a pressurization component configured to pressurize a space between the surface features of the pin component and the surface features of the box component, said pressurization configured to separate the surface features of the pin component from the surface features of the box component.

Some embodiments of the present connector systems comprise: a pin component defining a hollow interior region and having a tapered exterior surface with a plurality of teeth; a box component having a tapered interior surface with a plurality of teeth configured to engage the teeth of the pin component; and a guide pin having a tapered exterior surface projecting beyond a mating end of the box component, the tapered exterior surface of the guide pin configured to extend into the hollow interior region of the pin component to center the box component relative to the pin component. In some embodiments, at least one of the pin component and the box component is slidably coupled to a structural member such that pin component can be engaged with the box component separately from the guide pin being inserted into the hollow interior region of the box component. Some embodiments further comprise: an elastomeric bumper disposed within the box component and configured to deform to permit insertion of the pin component. Some embodiments further comprise: a pressurization component configured to pressurize an interface between the exterior surface of the pin component and the interior surface of the box component. In some embodiments, the pin component is attached to a first modular component and the box component is attached to a second modular component. In some embodiments, the engagement of the teeth of the pin component to the teeth of the box component attaches the pin component to the box component. In some embodiments, the pin component and the box component are configured to be separated by pressurization of the external surface of the pin component and the internal surface of the box component.

Some embodiments of the present modular structures (e.g., for supporting an offshore platform) comprise: a first module comprising a pin component having a tapered exterior surface with a plurality of teeth; and a second module comprising a box component having a tapered interior surface with a plurality of teeth configured to engage the teeth of the pin component; where the pin component is configured to engage the box component to attach the first module to the second module without welding the pin component to the box component. In some embodiments, at least one of the pin component and the box component is slidably coupled to a structural member such that pin component can be engaged with the box component without movement of the first module relative to the second module. In some embodiments, the pin component defines a hollow interior region, and the modular structure further comprises: a guide pin having a tapered exterior surface projecting beyond a mating end of the box component, the tapered exterior surface of the guide pin configured to extend into the hollow interior region of the pin component to center the box component relative to the pin component. Some embodiments further comprise: a bumper disposed within the box component and configured to deform to permit insertion of the pin component. Some embodiments further comprise: a pressurization component configured to pressurize an interface between the exterior surface of the pin component and the interior surface of the box component. In some embodiments, the engagement of the teeth of the pin component to the teeth of the box component attaches the pin component to the box component. In some embodiments, the pin component and the box component are configured to be separated by pressurization of the external surface of the pin component and the internal surface of the box component. In some embodiments, the first module comprises a plurality of the pin components, and the second module comprises a plurality of the box components configured to be simultaneously engaged to the plurality of pin components to attached the first module to the second module. In other embodiments, the first module comprises a plurality of the pin components, and the second module comprises a plurality of the box components configured to be sequentially engaged to the plurality of pin components to attached the first module to the second module. In some embodiments, the first module comprises a foundation structure configured to be coupled to a sea bed; the second module comprises a buoyant tower having an upper end configured to support a topside module or platform, a lower end, and a box component coupled to the lower end, the box component having a tapered interior surface with a plurality of teeth configured to engage the teeth of the pin component; and the pin component is configured to engage the box component to attach the buoyant tower to the foundation structure without welding the pin component to the box component.

Some embodiments of the present methods of connecting two structures comprise: disposing a second module over a first module, where: the first module comprises a pin component having a tapered exterior surface with a plurality of teeth; the second module comprises a box component having a tapered interior surface with a plurality of teeth configured to engage the teeth of the pin component; and pressing the pin component and the box component together such that the pin component engages the box component to attach the first module to the second module without welding the pin component to the box component. In some embodiments, at least one of the pin component and the box component is slidably coupled to a structural member such that pin component can be engaged with the box component without movement of the first module relative to the second module. In some embodiments, the pin component defines a hollow interior region, and a guide pin having a tapered exterior surface projects beyond a mating end of the box component, the tapered exterior surface of the guide pin configured to extend into the hollow interior region of the pin component to center the box component relative to the pin component. In some embodiments, a bumper is disposed within the box component and configured to deform to permit insertion of the pin component. In some embodiments, the engagement of the teeth of the pin component to the teeth of the box component attaches the pin component to the box component. In some embodiments, the pin component and the box component are configured to be separated by pressurization of the external surface of the pin component and the internal surface of the box component. In some embodiments, the first and second modules are pressed together by lowering the second module onto the first module. In some embodiments, lowering the second module comprises reducing the buoyancy of a vessel supporting the second module. In some embodiments, lowering the second module comprises reducing the buoyancy of the second module. In some embodiments, lowering the second module comprises actuating a crane from which the second module is suspended. In some embodiments, the first and second modules are pressed together by increasing the buoyancy of the first module. In some embodiments, the first module comprises a plurality of the pin components, and the second module comprises a plurality of the box components configured to be simultaneously engaged to the plurality of pin components to attached the first module to the second module. In other embodiments, the first module comprises a plurality of the pin components, and the second module comprises a plurality of the box components configured to be sequentially engaged to the plurality of pin components to attached the first module to the second module. Some embodiments further comprise: sequentially engaging each pin component with a corresponding box component. In some embodiments, the first module comprises a foundation structure configured to be coupled to a sea bed; the second module comprises a buoyant tower having an upper end configured to support a topside module or platform, a lower end, and a box component coupled to the lower end, the box component having a tapered interior surface with a plurality of teeth configured to engage the teeth of the pin component; and the pin component is configured to engage the box component to attach the buoyant tower to the foundation structure without welding the pin component to the box component.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are described below.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1A is a cross sectional view of the components of an embodiment of the connector according to aspects of the present disclosure in a separated configuration.

FIG. 1B is a cross sectional view of the components of an embodiment of the connector according to aspects of the present disclosure in an assembled configuration.

FIGS. 2A, 2B, and 2C illustrate one embodiment of assembling an exemplary modular structure in shallow water according to the aspects of the present disclosure.

FIG. 2D illustrates an exemplary embodiment of a guide pin according to certain aspects of the present invention.

FIGS. 3A, 3B, 3C, and 3D illustrate one embodiment of assembling an exemplary modular structure in intermediate water according to the aspects of the present disclosure.

FIGS. 4A and 4B illustrate one embodiment of assembling an exemplary modular structure in deeper water according to the aspects of the present disclosure.

FIGS. 5A, 5B, 5C, 5D, 5E, and 5F illustrate one embodiment of disassembling an exemplary modular structure according to the aspects of the present disclosure.

FIG. 6A is a cross sectional view of the components of a second embodiment of the connector according to aspects of the present disclosure in a separated configuration.

FIG. 6B is a cross sectional view of the components of the second embodiment of the connector according to aspects of the present disclosure in an assembled configuration.

FIG. 7 depicts a float-over installation of a top side module to a supporting structure.

FIG. 8 illustrates an LMU (Leg Mating Units) or DMU (Deck Mating Units) in separated and connected configurations.

FIG. 9 illustrates an embodiment of the present structural connectors in separated and connected configurations.

FIG. 10 depicts a make-up tool coupled to an embodiment of the present structural connectors.

FIG. 11 depicts a hydraulic power unit coupled to an embodiment of the present structural connectors.

FIG. 12 depicts a side view of a buoyant tower coupled to a semi-permanent base or foundation by an embodiment of the present structural connectors.

FIG. 13A is a cross sectional view of the components of a third embodiment of the connector according to aspects of the present disclosure in a separated configuration.

FIG. 13B is a cross sectional view of the components of the third embodiment of the connector according to aspects of the present disclosure in an intermediate configuration.

FIG. 13C is a cross sectional view of the components of the third embodiment of the connector according to aspects of the present disclosure in an assembled configuration.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF ILLUSTRATIVE EMBODIMENTS

Certain embodiments of the present disclosure replaces the welding of interfaces between structural components and modules with a connector that generally does not require external inputs other than grease and sufficient axial compression load to place into the assembled configuration. Once assembled, embodiments of the connector of the present disclosure provides a seam between structural components with sufficient mechanical strength to maintain the assembled configuration, such as that provided by welding of the interface. Unlike the permanent attachment of welding, embodiments of the connector of the present disclosure can be disassembled back into separate components to be assembled again at a later time. The disassembling process generally involves application of an internal pressure and an adequate axial tension load.

Certain embodiments of the present disclosure employ the connector of the present disclosure to assemble and disassemble modular structural components for purposes of constructing (and deconstructing) structures at remote locations in-situ, particularly offshore platforms, without the need for on-site welding, or cutting. The modular nature of the components used in the assembly process provides a means of achieving great flexibility in the custom configuring of each installation. When the desired overall structure is installed or constructed, it can be configured to suit the specific functional requirements of the particular installation site. Then, when desired, it can then be disassembled, relocated, and reassembled in a new configuration, using some or all of the same components, to accommodate a different set of functional requirements and installation parameters (such as water depth, currents, atmospheric conditions and seabed conditions). In one embodiment, large structures, such as offshore platforms, formed with two or more modular structural components disclosed in the present disclosure can be used in waters up to about 500 feet. In another embodiment, two or more modular structural components described in the present disclosure can be used to form large structures of certain heights for land use, such as towers.

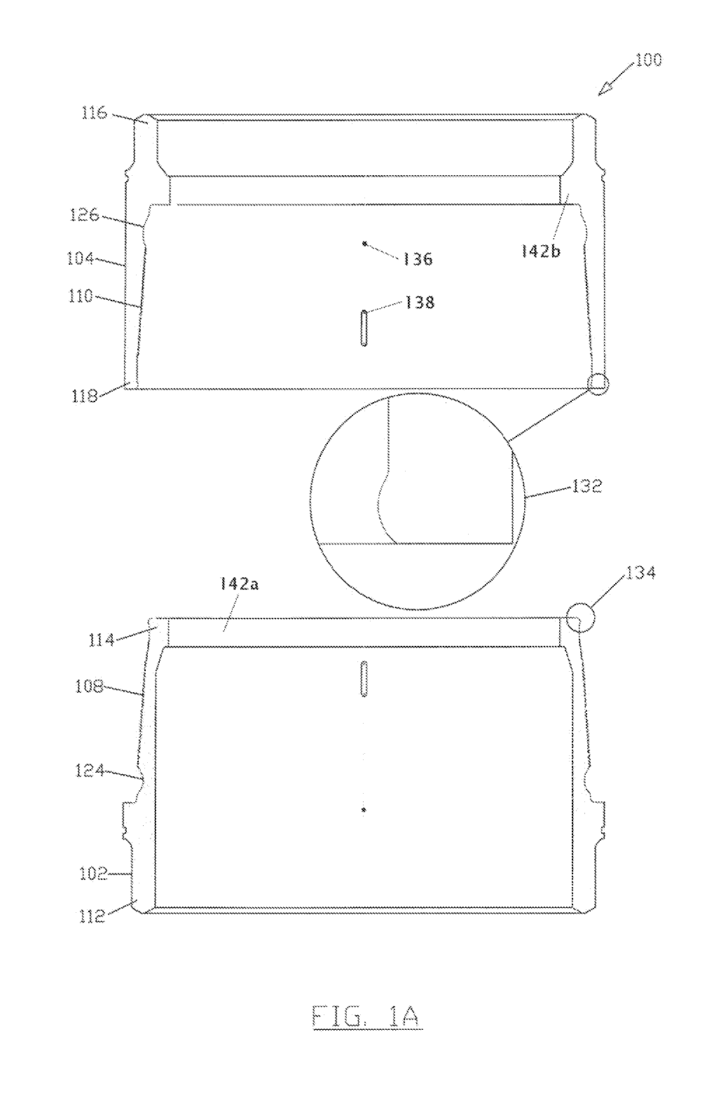

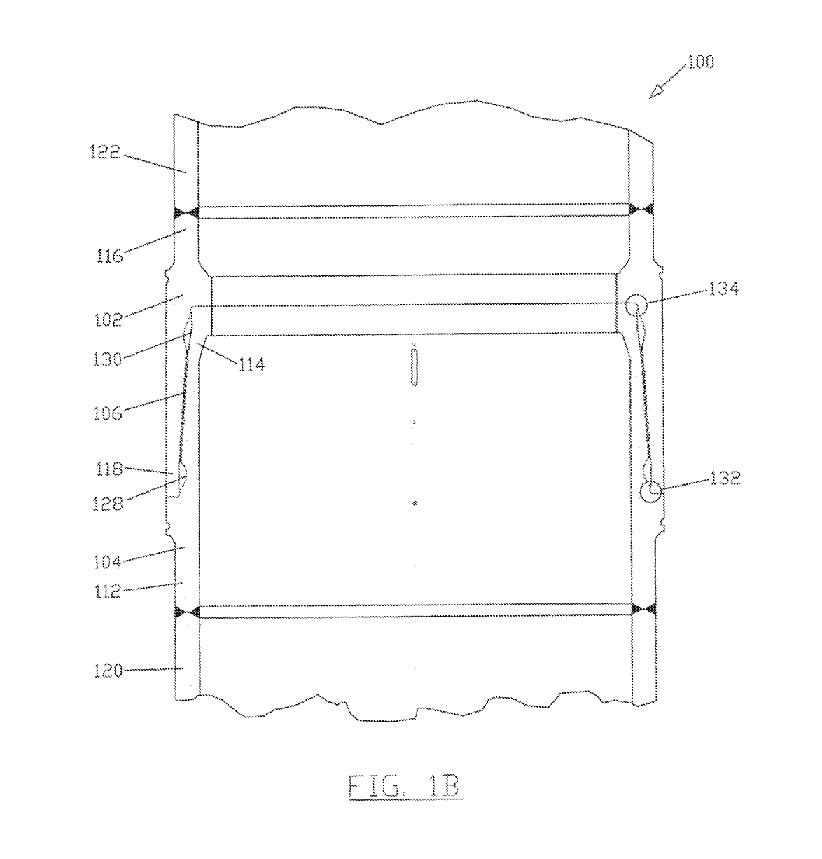

Specific exemplary embodiments of the connector of the present disclosure is discussed further below as well as depicted in FIGS. 1A-1B. FIG. 1A illustrates the components of connector 100 in the disassembled configuration while FIG. 1B shows the components of connector 100 in the assembled configuration. Referring to FIGS. 1A and 1B, connector 100 comprises pin component 102 and box component 104, each of which comprises a structural end and an interface end. Referring to FIGS. 1A and 1B, pin component 102 comprises structural end 112 that is attached to modular structure 120 and interface end 114 configured to engage with interface end 118 of box component 104 to form interface 106. Box component also comprises structural end 116 attached to modular structure 122 that needs to be assembled with modular structure 120. In one embodiment, modular structures 120 and 122 are attached to pin component 102 and box component 104, respectively, by welding that is preferably done prior to transporting of the attached structures to the construction site. In other embodiments, other appropriate means can be used to attach the modular structures, whether at the construction site or prior to that.

Referring to FIGS. 1A and 1B, both pin component 102 and box component 104 are preferably generally cylindrical with a hollow interior. The wall of both pin component 102 and box component 104 are sufficiently thick to support the assembled configuration of the overall structure. Interface end 114 of pin component 102 is preferably configured to be inserted into interface end 118 of box component 104. In other embodiments, however, box component 104 is designed to be inserted into pin component 102. The thickness of the wall of both interface ends 114 and 118 is generally thinner than the thickness of the wall of structural ends 112 and 116. The dimension and shape of structural ends 112 and 116 preferably match the dimension and shape of modular structures 120 and 122, respectively.

In the preferred embodiment, interface 106 comprises complementary interlocking engagement disposed on pin component 102 and box component 104 at or around interface ends 114 and 118, respectively. Interface ends 114 and 118 preferably have matching conical shape to facilitate the assembling process of connector 100 and the attached modular structures 120 and 122. In one embodiment, pin component 102 comprises external teeth 108 (e.g., coaxial threads that are not helical) disposed on the exterior wall of pin component 102, which are configured to interlock with complementary internal teeth 110 (e.g., coaxial threads that are not helical) disposed on the interior wall of box component 104 when pin component 102 is inserted into box component 104 forming interface 106 in the assembled configuration. External teeth 108 and internal teeth 110 preferably comprise a series of complementary parallel concentric peaks and dips, which can have any appropriate shape to provide a sufficient interlock of pin component 102 and box component 104. Exemplary shapes include generally round or sharp peaks and dips. Further, each peak or dip can be spaced apart or adjacent one another. In the preferred embodiment, external teeth 108 and internal teeth 110 are designed to slide over one another until they reach the assembled position. Further, they are preferably spaced so that they cannot interlock until pin component 102 is fully inserted into box component 104. In an embodiment where box component 104 is inserted into pin component 102, it is understood that the interface between the components would comprise internal teeth disposed on the interior wall of pin component 102 and external teeth disposed on the exterior wall of box component 104. In the preferred embodiment, interface end 118 of box component 104 is flexible enough to allow the expansion necessary for certain portions of internal teeth 110 to move past certain portions of external teeth 108 to snap into the assembled configuration when pin component 102 is inserted. In one embodiment, this is at least achieved by the material of box component 104 and/or the thinner wall of interface 118. In one embodiment, the threads of external teeth 108 and internal teeth 110 are machined into the respective surface of pin component 102 and box component 104.

Prior to assembling of connector 100, at least one of external teeth 108 and internal teeth 110 are preferably lubricated. An example of lubrication is heavy marine grease. The preferred assembling process begins with interface end 114 of pin component 102 facing upward and interface end 118 descending down over pin component 102. The outer diameter and corresponding inner diameter conical arrangement of interface 106 preferably allows pin component 102 and box component 104 to be self-centering. In certain circumstances where the weight of modular structure 122 is substantial, the weight itself may be employed in the assembly process to provide the force necessary to reach full engagement between pin component 102 and box component 104. In certain circumstances where the weight of modular structure 122 is insufficient to provide the full engagement between pin component 102 and box component 104, it is preferred to employ an assembling tool coupled to a power source. The assembling tool is preferably hydraulically controlled. An exemplary hydraulic power source is a Hydraulic Power Unit or HPU. One exemplary embodiment of an assembling tool comprises two sets of hinged arms designed to wrap around pin component 102 and box component 104, respectively and engage with a plurality of grooves provided in the outer diameter of pin component 102 and box component 104. The hinged arms are connected by an array of hydraulic cylinders, which are configured to apply an axial force to pin component 102 and box component 104 when the arms are locked into their respective engagement grooves. The force applied by the hydraulic cylinders can either be in tension or in compression. Both the exterior wall of pin component 102 and box component 104 preferably comprises a plurality of grooves configured to allow the assembling tool to grab both components and apply sufficient force to fully engage them with one another.

The assembling process of snapping or engaging pin component 102 and box component 104 together as described above can be repeated for each applicable modular structure until construction of the overall structure is completed. When the structure is no longer needed or its configuration needs to be modified, the structure can be disassembled by separating pin component 102 from the corresponding box component 104. This option of being able to break the connection and recover the piece of equipment or structure is an attractive solution when said equipment is likely to be removed, replaced or relocated after an interval of time. In the preferred embodiment, external teeth 108 and internal teeth 110 are configured to separate when the annular space between them is pressurized to a designated threshold pressure while an axial tension is applied to pull pin component 102 and box component 104 apart. The axial tension applied is in excess of the structural weight of box component 104 and the attached modular structure 122.

Referring to FIGS. 1A and 1B, both pin component 102 and box component 104 comprise indentations 124 and 126, respectively, that provide annulus gap 128 and annulus gap 130 disposed between the outer wall of pin component 102 and inner wall of box component 104. Pressure in annulus gap 128, annulus gap 130, and interface 106 is maintained initially at least by sealing nib 132 on box component 104 and sealing nib 134 on pin component 102. Interface 106 is preferably disposed between gap 128 and gap 130. In the preferred embodiment, pressurization of the annulus between the threads of external teeth 108 and internal teeth 110 pin is facilitated by pressure input port 136 and bleed ports 138. In one embodiment, pressurization is accomplished by connecting a hydraulic hose from a Hydraulic Power Unit to pressure input port 136 while bleed ports 138 are plugged. Once the annular space is pressurized to a designated threshold pressure, external teeth 108 and internal teeth 110 separate from one another sufficiently to allow the applied axial tension to pull pin component 102 and box component 104 apart. The internal pressure acting on the respective conical surfaces of interface ends 114 and 118 to disengage the interlocked teeth as well as assist in forcing pin component 102 and box component 104 apart. As will be appreciated by those of ordinary skill in the art, various thickness and dimensions of the depicted embodiments may be varied to vary certain characteristics of the present connectors. For example, the thicknesses of abutment flanges 142a and 142b may be reduced to increase radial flexibility of the pin and box components.

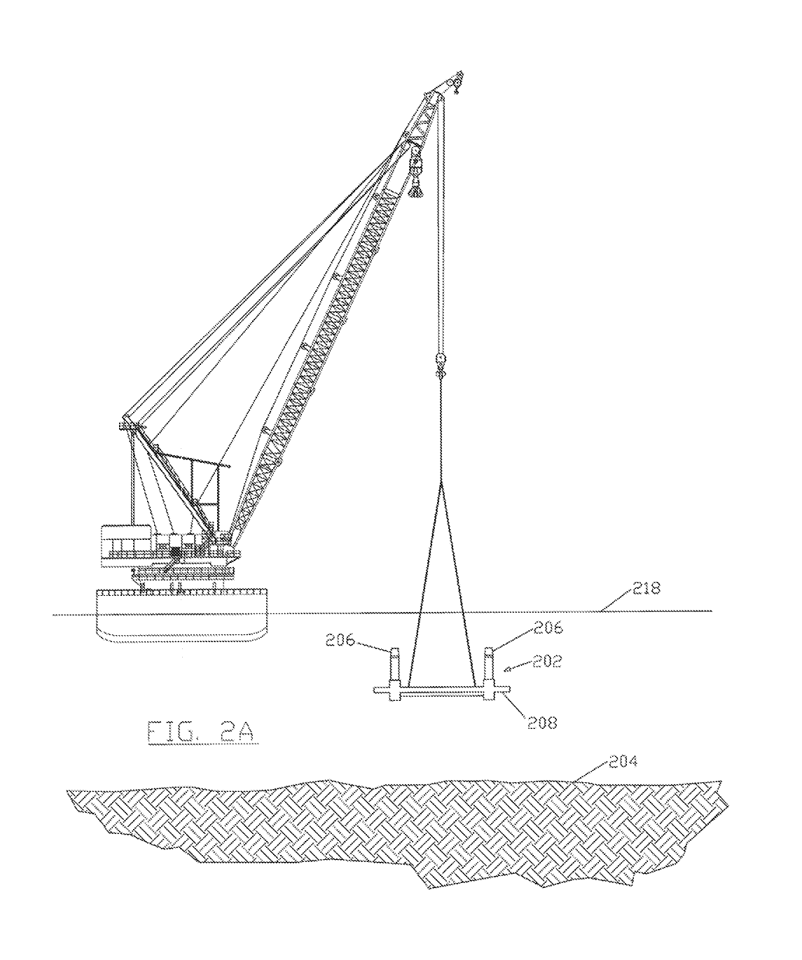

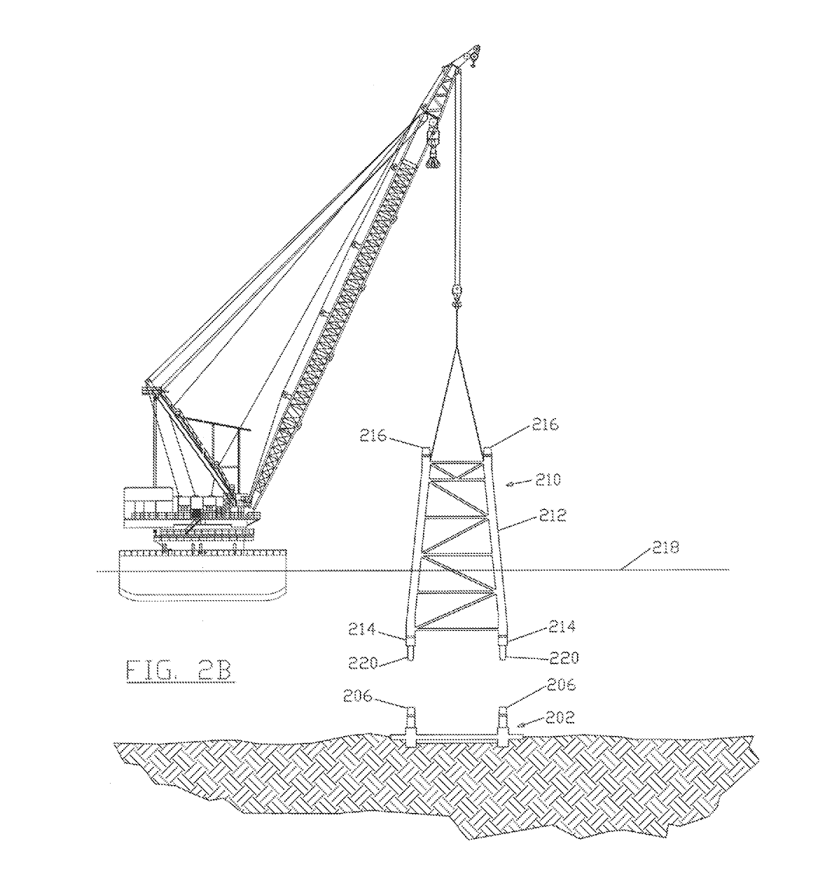

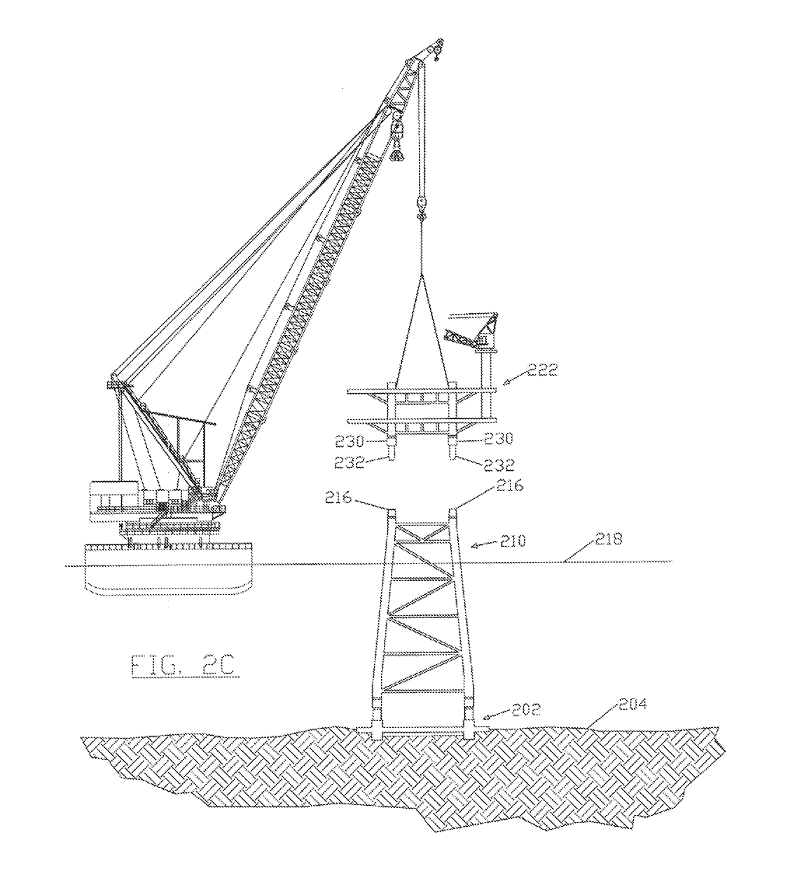

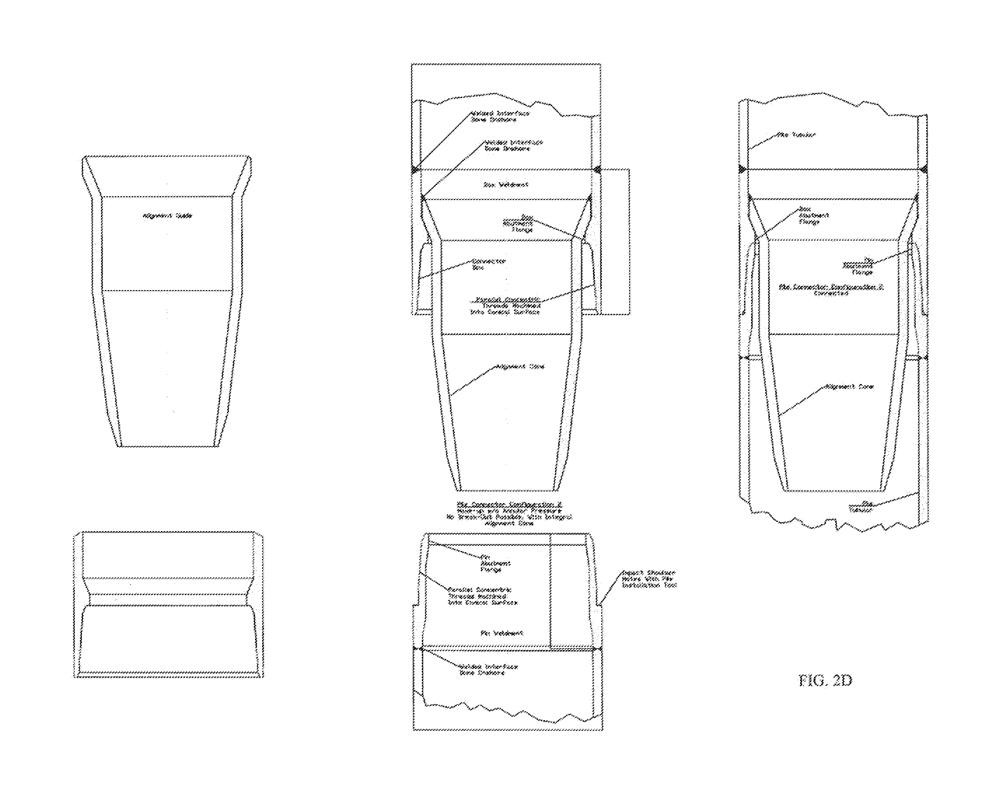

Embodiments of the connector of the present disclosure are applicable to allow assembly and disassembly of various types of structures to be located in a variety of environments. Certain embodiments are particularly applicable for erecting and disassembling of offshore platforms typically used in the oil and gas industry as known by those of ordinary skill in the art. While the following description provides construction and removal details of an offshore platform situated in the ocean, one of ordinary skill in the art would understand they are equally applicable to constructing and removing of any structure, whether on land or in water locations. In one embodiment, construction of offshore platforms employing the embodiments of the present disclosure preferably comprises a foundation module, at least one jacket module, and a top side module. The foundation module sits on the ocean floor and serves as the foundation of the platform. The jacket module serves as support of the structure and provide the height to elevate the top side module above the body of water. The top side module sits above the jacket module. In shallow water, the structure may need only one jacket module while in intermediate or deeper waters, more than one jacket module are needed to sufficiently elevate the top side module above the water surface. The top side module can include any modular structure that is necessary for the particular operation. For example, the top side module can include but is not limited to a drill derrick, personnel accommodations, processing units, or any combination thereof. As shown in FIGS. 2A-2C, a floating crane is used to provide vertical movement of the various modules, such as lowering and lifting. In other embodiments, however, other suitable means known to those of ordinary skill in the art can be used in the assembling and disassembling process as described further below.

FIGS. 2A, 2B, and 2C illustrate one embodiment of assembling an exemplary modular structure in shallow water according to the aspects of the present disclosure. A non-limiting exemplary depth of shallow water for jacket structures sitting on the seabed is about 150 feet or less. In one embodiment, construction at shallow water sites does not need more than one jacket module to support the top sides package at an elevation well above the surface of the water. In other embodiments, however, the overall structure installed at shallow water sites can be customized with multiple jacket modules of various heights to achieve any desired or appropriate elevation above the water surface.

Referring to FIG. 2A, foundation module 202 is deployed to sea bed 204 at the selected installation site and then leveled. Leveling of foundation module 202 can be accomplished by any one of several methods currently employed in the offshore industry or known to those of ordinary skill in the art. The method selected will likely depend on the soil or seabed conditions at the installation site. In the preferred embodiment, foundation module 202 comprises a generally horizontal base portion closest to sea bed 204 and pin components 206. In the preferred embodiment, foundation module 202 has four pin components 206. The number of pin components 206 corresponds to the number of corners of the installed platform and can be modified as appropriate for the particular application and structure. In one embodiment, pin components 206 are coupled to base portion 208 through an intermediate body. In another embodiment, pin components 206 are directly attached to base portion 208. The descriptions of the connector components (e.g., 102 and 104) of FIGS. 1A and 1B are equally applicable to connector components (e.g., 206 and 214) of FIGS. 2A, 2B, and 2C and thus are not repeated. In the preferred embodiment, the threaded portions on pin components 206 are lubricated prior to deployment of foundation module 202. Referring to FIG. 2A, when deployed, base portion 208 sits directly on top of sea bed 204 below water level 218, and pin components 206 sit above base portion 208 to receive jacket module 210.

Referring to FIG. 2B, the assembly process continues with deployment of jacket module 210 toward foundation module 202 that has been leveled and ready to accept load. Jacket module 210 comprises body 212, box components 214 coupled to the bottom of body 212, and pin components 216 coupled to the top of body 212. As shown, body 212 has four sides and a general shape of a truncated pyramid with the base being larger than the top. In other embodiments, however, body 212 can have any desired or appropriate shape for the particular application.

Referring to FIG. 2B, pin components 206 are configured to be inserted into box components 214 to connect foundation module 202 and jacket module 210 together. In the preferred embodiment, box component 214 further comprises guide pins 220 that protrude from the inner diameter of box components 214 to assist in the alignment of multiple pin component-box component engagements. FIG. 2D illustrates one exemplary embodiment of guide pin 220. The threaded areas of box components 214 are also preferably lubricated prior to coupling of the two components. In certain embodiments remotely operated vehicles (“ROVs”) are further provided for inspection purposes during the installation.

Once box components 214 have been situated over the corresponding pin component 206 with the help of guide pins 220, jacket module 210 is lowered, thereby inserting guide pins 220 into the corresponding pin component 206. Lowering of jacket module 210 continues until the downward pointing box components 214 descend over the upward pointing pin components 206. Prior to release of jacket module 210 to fully engage pin components 206 and box components 214, the process is preferably halted for inspection and confirmation of alignment. In one embodiment, verification of the distance between one pin component 206 to its matching box component 214 is the approximately the same for each set is performed to ensure jacket module 210 is leveled with foundation module 202. Once these parameters are confirmed, lowering of jacket module 210 resumes until pin components 206 fully engage the respective box components 214. In the preferred embodiment, the weight of jacket module 210 provides sufficient force to achieve the appropriate formation of the locking interface of pin components 206 and box components 214. As such, the lowering of jacket module 210 preferably need not be accompanied by any additional downward force. In other embodiments, however, if the weight of jacket module 210 is insufficient, additional force to fully engage pin components 206 and box components 214 can be provided as described above with an assembling tool or by other means known to those skilled in the art.

Referring to FIG. 2C, water level 218 is sufficiently shallow that the top of jacket module 210 is elevated above it. In other embodiments, if jacket module 210 is not as tall and/or if water level 218 is higher, additional jacket modules may be used and installed as described herein. Following installation of jacket module 210, the above process is repeated for installation of top side module 222. That is, top side module 222 comprises box components 230 into which pin components 216 are inserted to connect top side module 222 to jacket module 210. The assembly process for lowering top side module 222 onto jacket module 210 is similar to the process described above for lowering jacket module 210 onto foundation module 202. Box components 230 preferably includes guide pins 232 similar to guide pins 220 to assist in the alignment of box components 230 and pin components 216. As pointed out previously, top side module 222 can include any components appropriate or desirable for any purpose necessary to meet the needs and demands of the site and field installation and/or operation requirements. Further, top side module 222 can itself comprise more than one module coupled together using the connectors of the present disclosure.

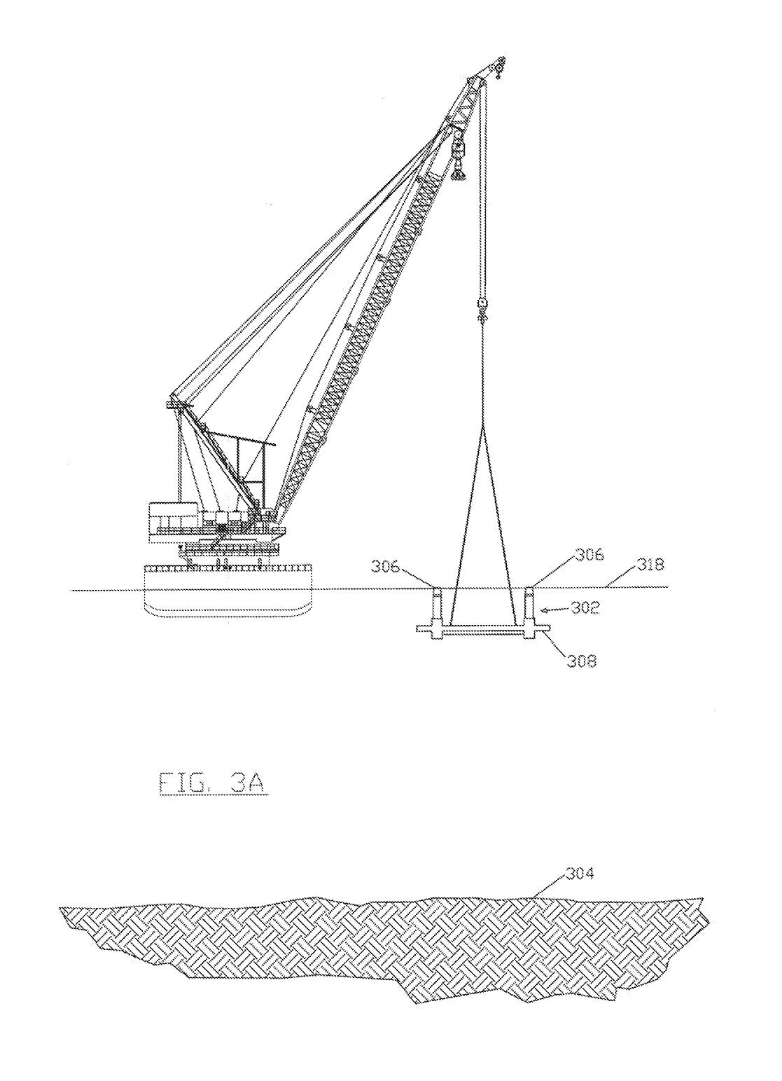

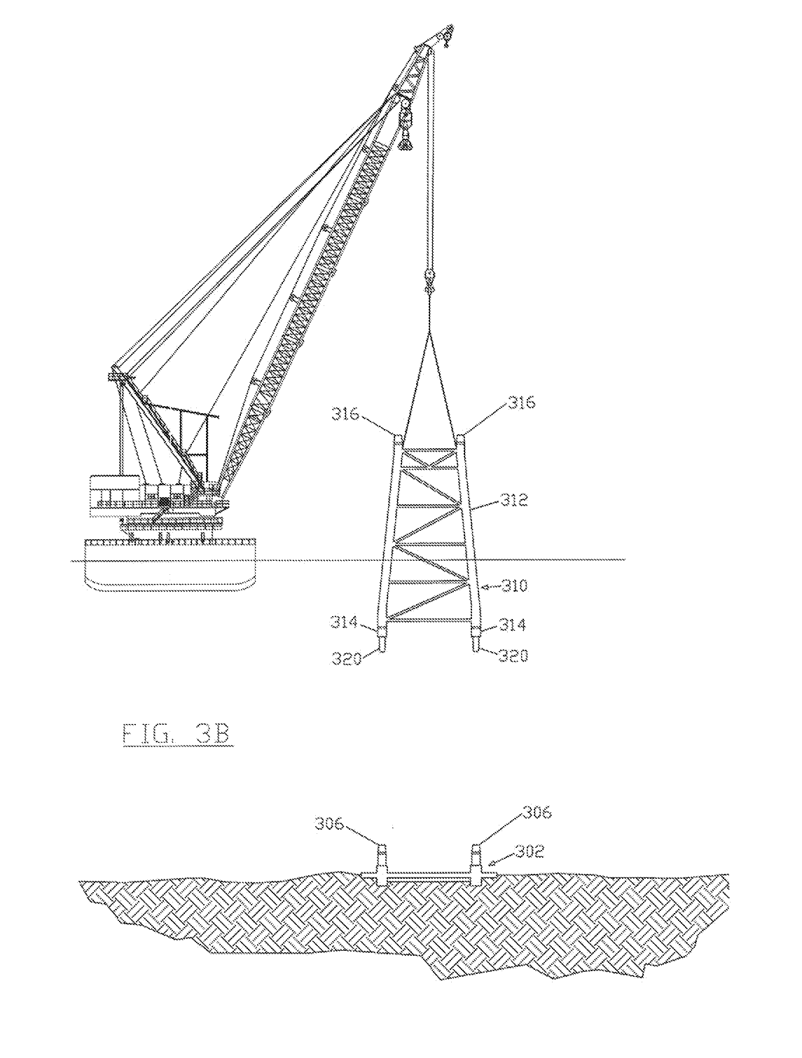

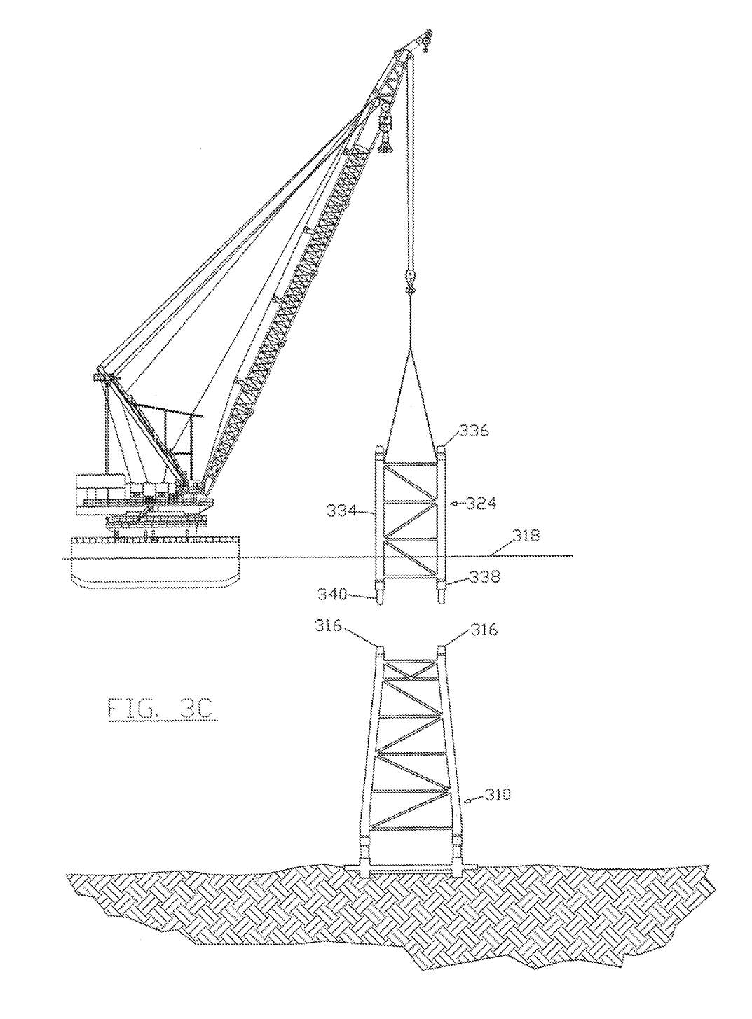

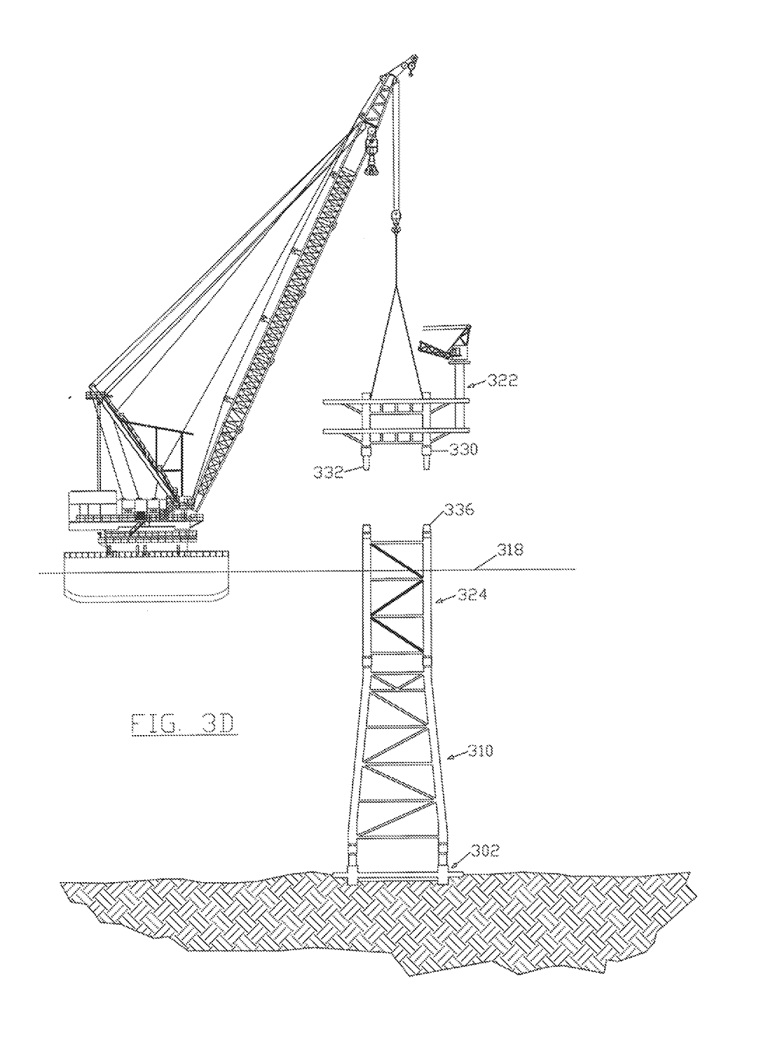

FIGS. 3A, 3B, 3C, and 3D illustrate one embodiment of assembling an exemplary modular structure in intermediate water according to the aspects of the present disclosure. In one non-limiting exemplary depth of intermediate water for jacket structures resting on the seabed is between about 150 feet and 300 feet. In one embodiment, construction at intermediate water sites needs about two to three jacket modules to support the top sides package at an elevation well above the surface of the water. In other embodiments, however, the overall structure installed at shallow water sites can be customized with the appropriate number of jacket modules of various heights to achieve any desired or appropriate elevation above the water surface. The constructed platform can be specifically configured to address soil conditions, water depth and local environmental conditions after assessment of the installation site has been made.

The installation process at intermediate water sites is substantially similar to the installation process at shallow water sites. The descriptions for FIGS. A, 2B, and 2C are equally applicable to the descriptions for FIGS. 3A, 3B, 3C, and 3D and are summarized below. Referring to FIG. 3A, foundation module 302 is deployed to sea bed 304 at the selected installation site and then leveled. Leveling of foundation module 302 can be accomplished by any one of several methods currently employed in the offshore industry or known to those of ordinary skill in the art. The method selected will likely depend on the soil or seabed conditions at the installation site. Foundation module 302 may be configured differently from foundation module 202 to accommodate the additional load from the additional jacket modules. In the preferred embodiment, foundation module 302 comprises a generally horizontal base portion closest to sea bed 304 and pin components 306. In one embodiment, pin components 306 are coupled to base portion 308 through an intermediate body. In another embodiment, pin components 306 are directly attached to base portion 308. The descriptions of the connector components (e.g., 102 and 104) of FIGS. 1A and 1B are equally applicable to connector components (e.g., 306 and 314) of FIGS. 3A, 3B, 3C, and 3D and thus are not repeated. In the preferred embodiment, the threaded portions on pin components 306 are lubricated prior to deployment of foundation module 302. Referring to FIG. 3A, when deployed, base portion 308 sits directly on top of sea bed 304 below water level 318, and pin components 306 sit above base portion 308 to receive jacket module 310.

Referring to FIG. 3B, the assembly process continues with deployment of jacket module 310 toward foundation module 302 that has been leveled and ready to accept load. Jacket module 310 comprises body 312, box components 314 coupled to the bottom of body 312, and pin components 316 coupled to the top of body 312. Pin components 306 are configured to be inserted into box components 314 to connect foundation module 302 and jacket module 310 together. In the preferred embodiment, each box component 314 further comprises guide pin 320 that protrude from the inner diameter of box component 314 to assist in the alignment of multiple pin component-box component engagements. The threaded areas of box components 314 are also preferably lubricated prior to coupling of the two components.

Once box components 314 have been situated over the corresponding pin component 306 with the help of guide pins 320, jacket module 310 is lowered, thereby inserting guide pins 320 into the corresponding pin component 306. Lowering of jacket module 310 continues until the downward pointing box components 314 descend over the upward pointing pin components 306. Prior to release of jacket module 310 to fully engage pin components 306 and box components 314, the process is preferably halted for inspection and confirmation of alignment. In one embodiment, verification of the distance between one pin component 306 to its matching box component 314 is the approximately the same for each set is performed to ensure jacket module 310 is leveled with foundation module 302. Once these spacing and alignment parameters are confirmed, lowering of jacket module 310 resumes until pin components 306 fully engage the respective box components 314. In the preferred embodiment, the weight of jacket module 310 provides sufficient force to achieve the appropriate formation of the locking interface of pin components 306 and box components 314. In other embodiments where the weight of jacket module 310 is insufficient, additional force to fully engage pin components 306 and box components 314 can be provided as described above.

Referring to FIG. 3C, installed jacket module 310 is still below water level 318. To provide sufficient elevation above water level 318, a second jacket module is needed. Following the installation of jacket module 310, the assembly process continues with deployment of jacket module 324. Like jacket module 310, jacket module 324 also comprises a body (334) coupled to pin components (336) and box components (338) to connect the second jacket module (324) to the first module (310) as well as a top side module (322) or another jacket module (not shown). Specifically as illustrated in FIG. 3C, pin components 316 are configured to be inserted into box components 338 to connect jacket module 310 and jacket module 324 together. The assembly process for lowering jacket module 324 onto jacket module 310 to fully engage the two components is similar to the process described above for lowering jacket module 310 onto foundation module 302. The descriptions provided above are equally applicable here and are not repeated. As shown, jacket module 324 has a generally rectangular shape. In other embodiments, however, the shape of jacket module 324 can match the shape of jacket module 310, or it can be any desired or appropriate shape depending on the application and/or location.

Following installation of jacket module 324, the above process is again repeated for installation of top side module 322. Specifically as illustrated in FIG. 3D, top side 322 comprises box components 330 that are configured to be inserted into pin components 336 to connect jacket module 324 and top side module 322 together. The assembly process for lowering top side module 322 onto jacket module 324 is similar to the process described above for lowering jacket module 310 onto foundation module 302. The descriptions provided above are equally applicable here and are not repeated. As pointed out previously, top side module 322 can include any components appropriate or desirable for any purpose necessary to meet the needs and demands of the site and field installation and/or operation requirements. Further, top side module 322 can itself comprise more than one module coupled together using the connectors of the present disclosure.

Certain deep water sites may require four to six jacket modules to support the top sides package at an elevation well above the surface of the water. A non-limiting exemplary depth considered deep for jackets standing on the seabed is at least about 300 feet. However, as pointed out previously, modules can be added to, or subtracted from, the structure as water depth and local environmental conditions warrant.

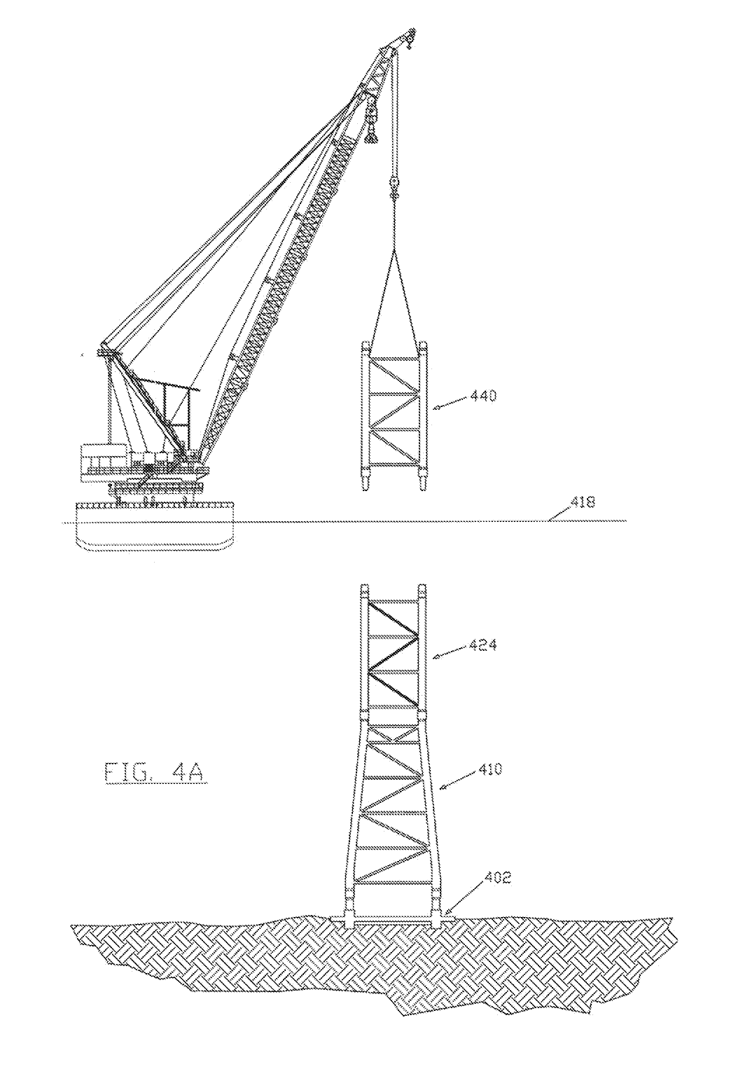

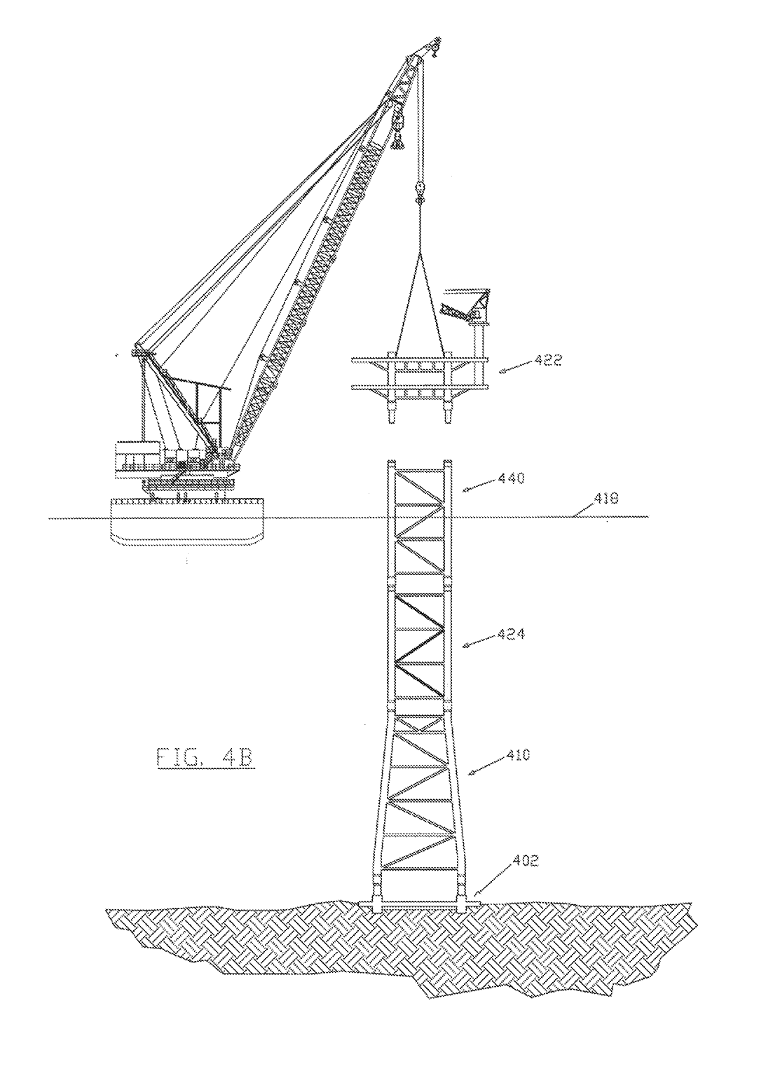

The installation of a platform or any modular structure in deep water using the embodiments of the present disclosure preferably involves the steps described above, except at least one additional jacket module is added to the structure before the top side module is installed. In particular, referring to FIG. 4A, deployment of foundation module 402 preferably employs the same process in deploying foundation module 202 of FIG. 2A and foundation module 302 of FIG. 3A. Similarly, deployment of jacket module 410 and jacket module 424 preferably employs the same process in deploying jacket module 310 of FIG. 2B and jacket modules 310 and 324 of FIGS. 3B and 3C, respectively. The descriptions provided above are equally applicable here and are not repeated. Foundation module 402 may be configured to accommodate the additional load of any added jacket module.

Referring to FIG. 4A, to provide elevation above water level 418, jacket module 440 is provided on top of jacket module 424. As shown, jacket module 440 is similar to jacket module 424, so descriptions for jacket module 424 are equally applicable here and are not repeated. That is, jacket module 440 includes box components at the bottom that slide over the pin components of jacket module 410 and pin components at the top that are configured to be inserted into the box components of top side module 422. The assembly process for lowering jacket module 440 onto jacket module 424 to fully engage the two components is similar to the process described above for lowering jacket module 310 onto foundation module 302. The descriptions provided above are equally applicable here and are not repeated. Referring to FIG. 4B, the addition of jacket module 440 provides sufficient elevation above water level 418 for top side module 422. Top side module 422 is then lowered on top of jacket module 440 preferably employing the process described above to lower top side module 222 of FIG. 2C and top side module 322 of FIG. 3D. As pointed out previously, top side module 422 can include any components appropriate or desirable for any purpose necessary to meet the needs and demands of the site and field installation and/or operation requirements. Further, top side module 422 can itself comprise more than one module coupled together using certain embodiments of the connectors described in the present disclosure.

Once the modular structure constructed according to aspects described here is no longer needed at the site or needs to be reinstalled elsewhere, it can be disassembled by disengaging the connector components to separate the modules. The disassembly process preferably begins with removal of the top module, then removal of each subsequent module below the top module. The procedure for removal of each module is generally the same as the work progresses downward. In the preferred embodiment, disconnection of the connectors of the present disclosure involves the following two events: (1) application of an axial tensile load tending to pull the pin component and box component apart, and (2) application of an internal pressure to the annular volume between the teeth of the pin components and the box components. In one embodiment, at least a portion of each event overlaps one another. For instance, in one embodiment, application of an axial tension load occurs while internal pressure is being applied.

In the preferred embodiment, all connector components at the particular interface subject to disassembling are subject to internal pressurization of the annulus between the teeth at the interface. The application of internal pressure is preferably abrupt rather than gradual and is applied to all applicable interfaces simultaneously. In the preferred embodiment, the simultaneous and abrupt pressure is achieved by providing each module with a hot stab panel, which is preferably hydraulically connected to each box component of that module. In one embodiment, the hot stab panel is pressurized by a hydraulic umbilical from an HPU located on an adjacent vessel. The hot stab panel acts as a manifold and distributes the injected pressure pulse to each box component. In other embodiments, however, other suitable devices can be used. Preferably suitable devices are ones that can accumulate pressure until the desired level is reached prior to delivery of that pressure. This way, pressurization at the desired level is provided immediately rather than gradually.

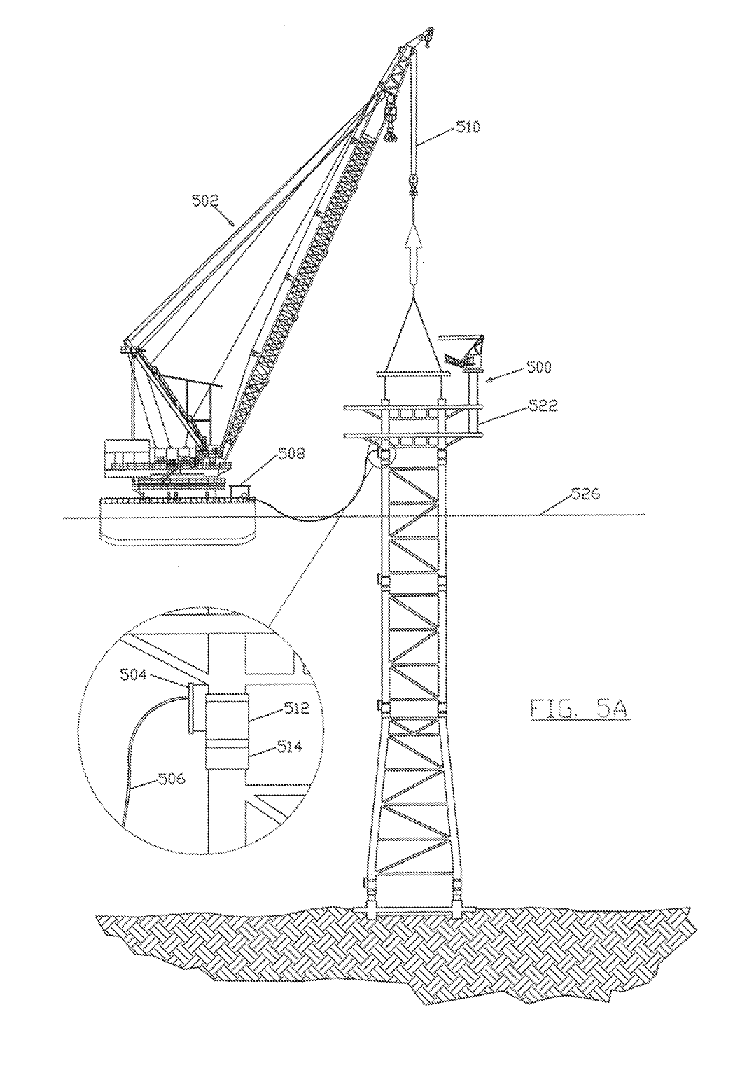

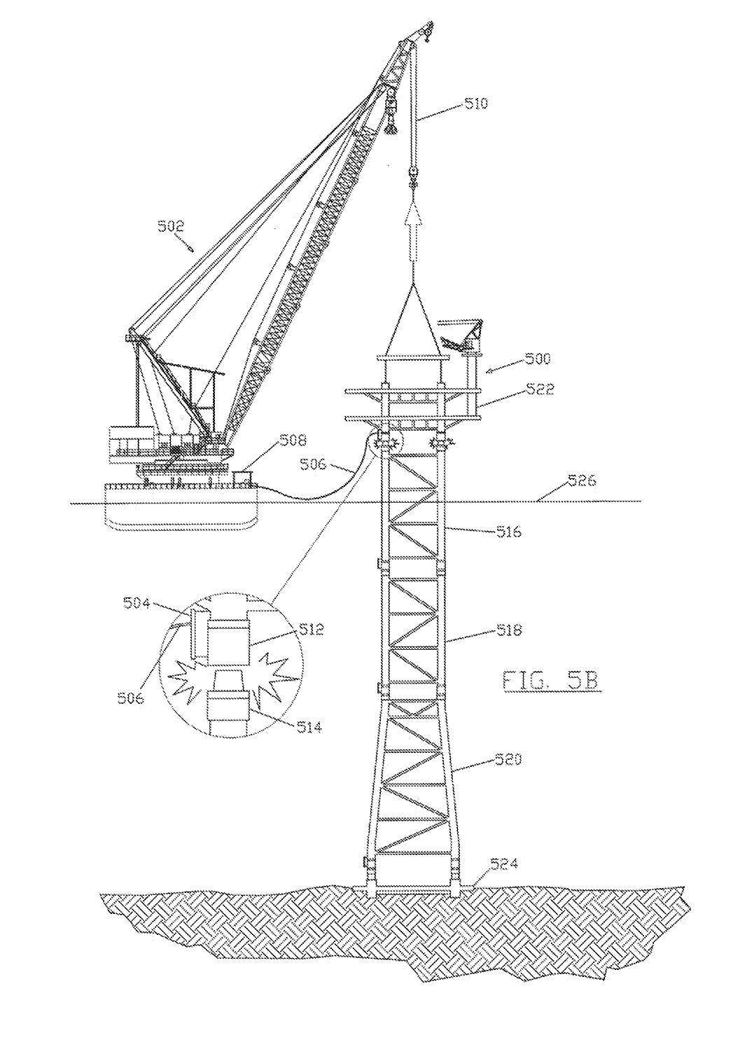

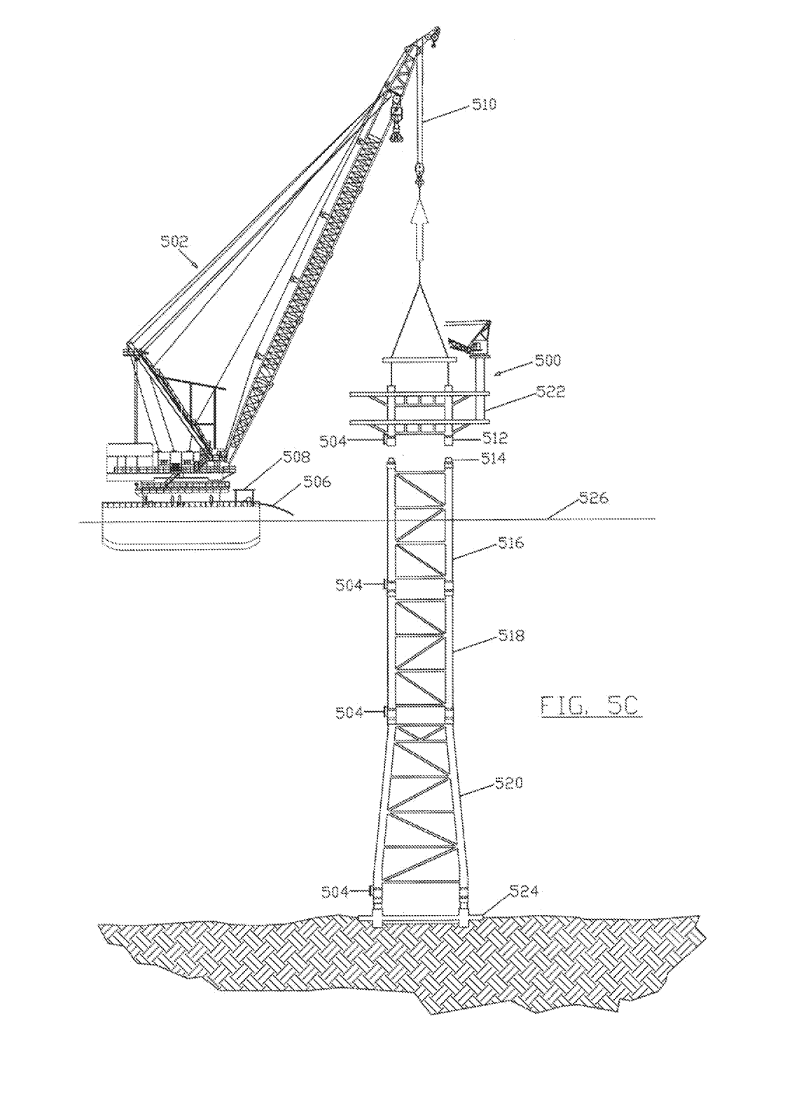

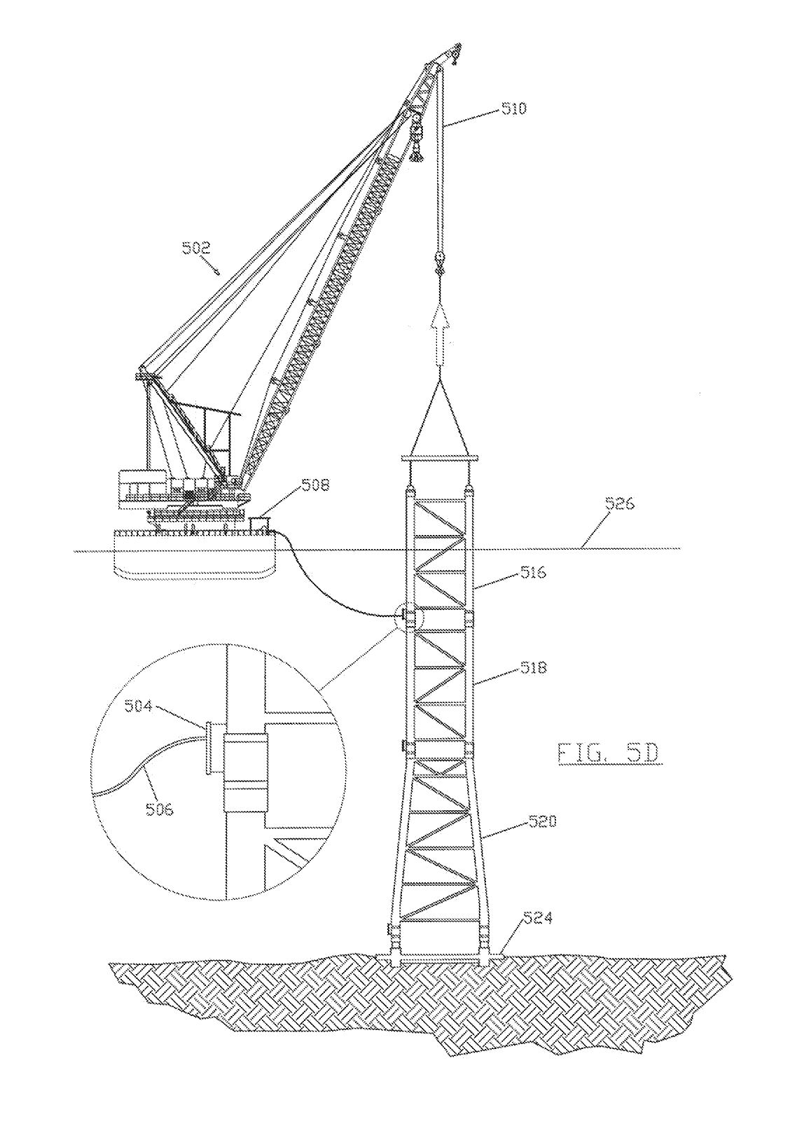

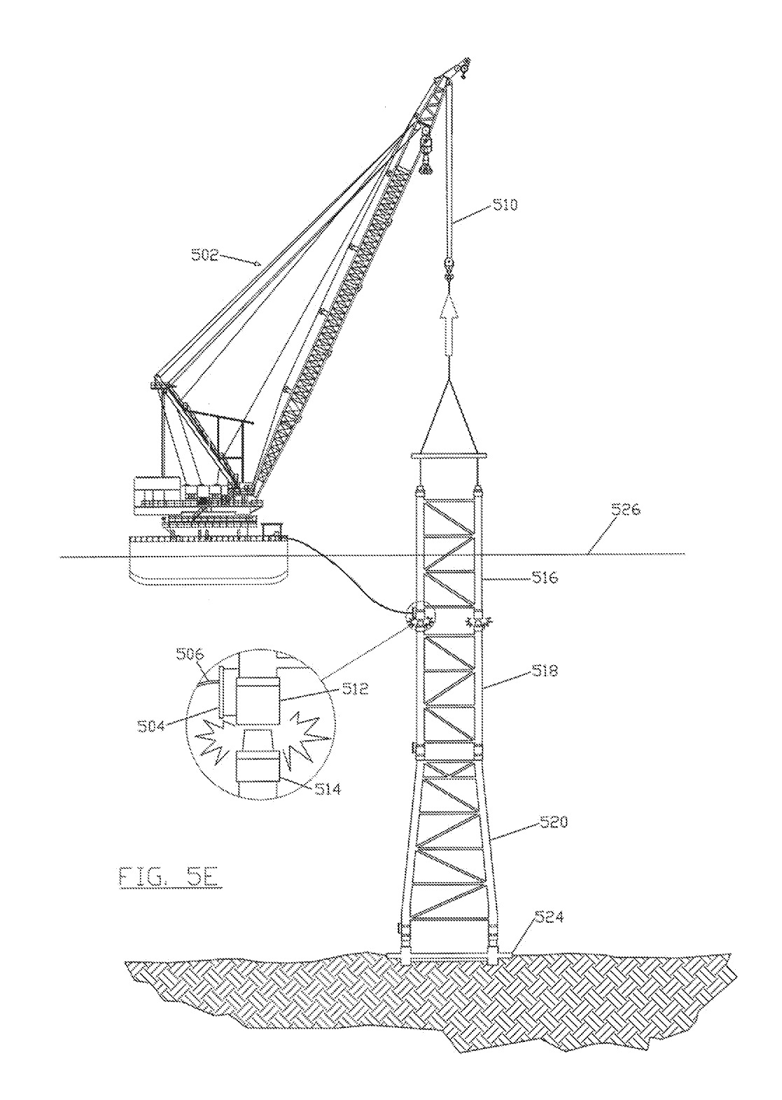

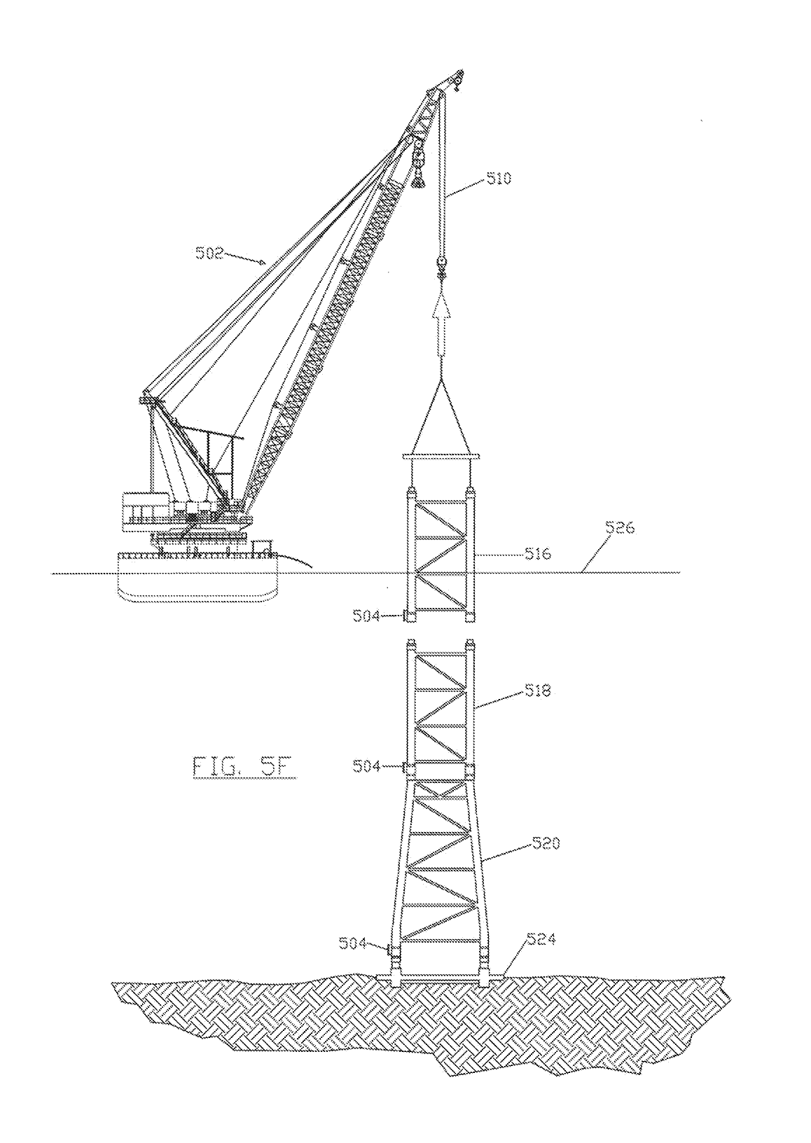

Disassembling of the modular structure constructed according to aspects of embodiments described in this disclosure preferably begin with functional packages that are installed on the top sides module, if any. After that, removal of the top sides module itself can take place. Sequences of a specific embodiment of the removal process are shown in FIGS. 5A-5F. In the preferred embodiment, crane 502 provides the vertical lift of the particular module being removed, such as top side module 522 in FIG. 5A. For an offshore construction site, crane 502 is preferably a floating crane known to those skilled in the art. Hot stab panel 504 is preferably actuated via hydraulic umbilical 506 coupled to HPU installation 508, which can be located on the crane barge as shown (or other adjacent vessel).

The removal process preferably begins with build-up of pressure to the desired level prior to application of the pressure to the annular space between the teeth of the connector components. If a hot stab panel is used, the pressure accumulation is achieved in the accumulator(s). In the preferred embodiment, the required vertical load is applied via crane wire 510 by actuating crane wire 510 in the upward direction. The vertical load applied is preferably in excess of the weight of the module being removed. Referring to FIG. 5B, while the vertical load is being applied, the pressure from the accumulator(s) is distributed via hot stab panel 504 to each box component. The pressure pulse is injected into the space between the teeth of all box components 512 of top module 522 and pin components 514 of the corresponding jacket module 516. With the pressurization of the space between the teeth of box components 512 and pin components 514 and the vertical load applied by crane 502, box components 512 and pin components 514 separate from one another, allowing top side module 522 to travel upwards. Referring to FIG. 5C, once separation has occurred, top side module 522 is preferably suspended in place at an elevation slightly above jacket module 516 while hydraulic umbilical 506 is disconnected from hot stab panel and recovered to HPU 508. In the preferred embodiment, top side module 522 is already above water level 526, so hydraulic umbilical 506 can be recovered manually. After recovery of hydraulic umbilical 506, top side module 522 may be removed from the overall structure, e.g., platform 500, and deposited on an adjacent barge for transport.

Referring to FIGS. 5D-5F, deconstruction of platform 500 continues with separation and removal of the various jacket modules (e.g., 516, 518, 520) in descending order starting with the top module, jacket module 516 to the lowest module, jacket module 520, and culminating in recovery of foundation module 524. Like removal of top side module 522, crane 502 is coupled to jacket module 516 to provide vertical lift. Hot stab panel 504 of jacket module 516 is preferably coupled to HPU installation 508 via hydraulic umbilical 506. HPU installation 508 provides the necessary power to actuate hot stab panel 504 to pressurize the space between the teeth of the interface between pairings of pin components and box components. Other suitable methods and/or devices can be used to actuate hot stab panel 504 or any other component that provides the desired pressurization. If hot stab panel 504 for jacket module 516 is below water level 526, connecting and disconnecting hydraulic umbilical 506 to any hot stab panel 504 under water preferably are done using a diver or an ROV (not shown).

Referring to FIG. 5E, as described for the separation of top side module 522, the necessary pressure level for pressurization of the space between pin components and box components of jacket modules 516 and 518 is preferably provided while crane 502 provides the necessary vertical load to jacket module 516. The pressurization of the teeth preferably provides sufficient space separating the pin components and box components from one another to allow the applied vertical load to pull jacket module 516 upwards and away from the remaining structure. Referring to FIG. 5F, once separation has occurred, jacket module 516 is preferably suspended in place at an elevation slightly above jacket module 518 while the umbilical is disconnected from the hot stab panel and recovered to the HPU installation. If hot stab panel 504 of jacket module 516 is still below water level 526, then hydraulic umbilical 506 can be disconnected and retrieved by a diver or an ROV. After recovery of the umbilical, jacket module 516 may be removed and deposited on an adjacent barge for transport. The sequence of steps of actuating hot stab panel 504 to pressurize sufficiently the interface between pin components and box components to separate the two and allow the top module to be lifted can be repeated for removal and retrieval of jacket modules 518 and 520. While the descriptions provide use of only one hydraulic umbilical, it is understood that other arrangements (such as more than one umbilical as) can be used to actuate hot stab panels 504. In another embodiment, multiple hydraulic umbilical from the HPU can be plugged directly into each of the particular box components without need for hot stab panels 504 and associated plumbing.

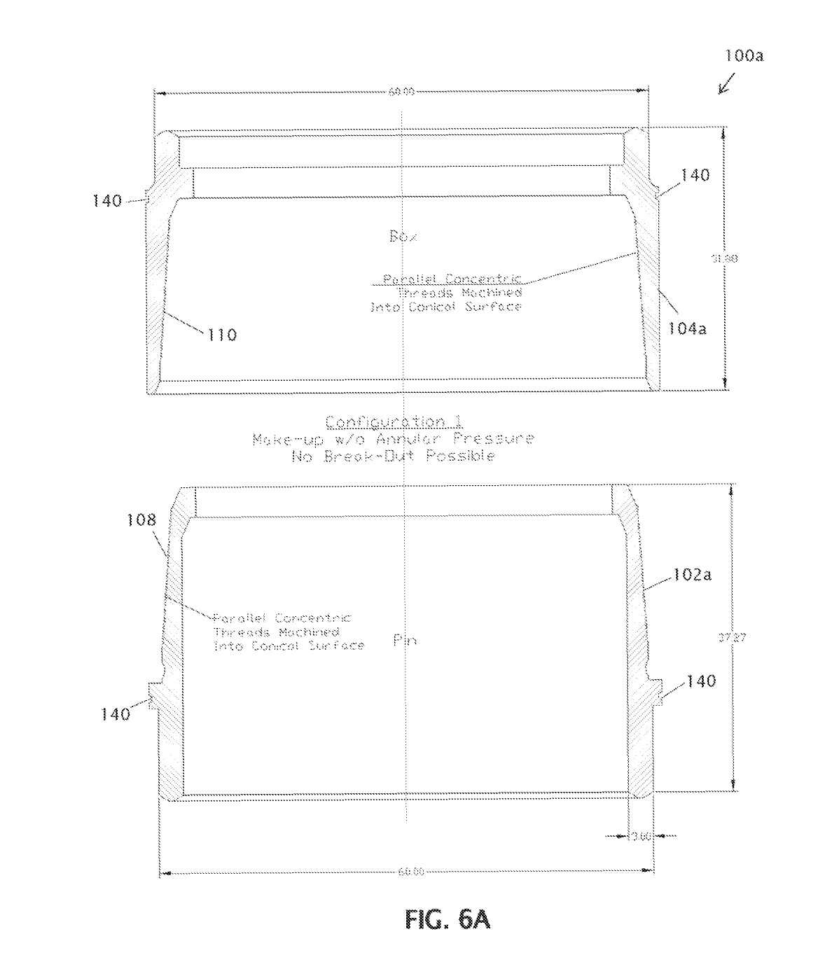

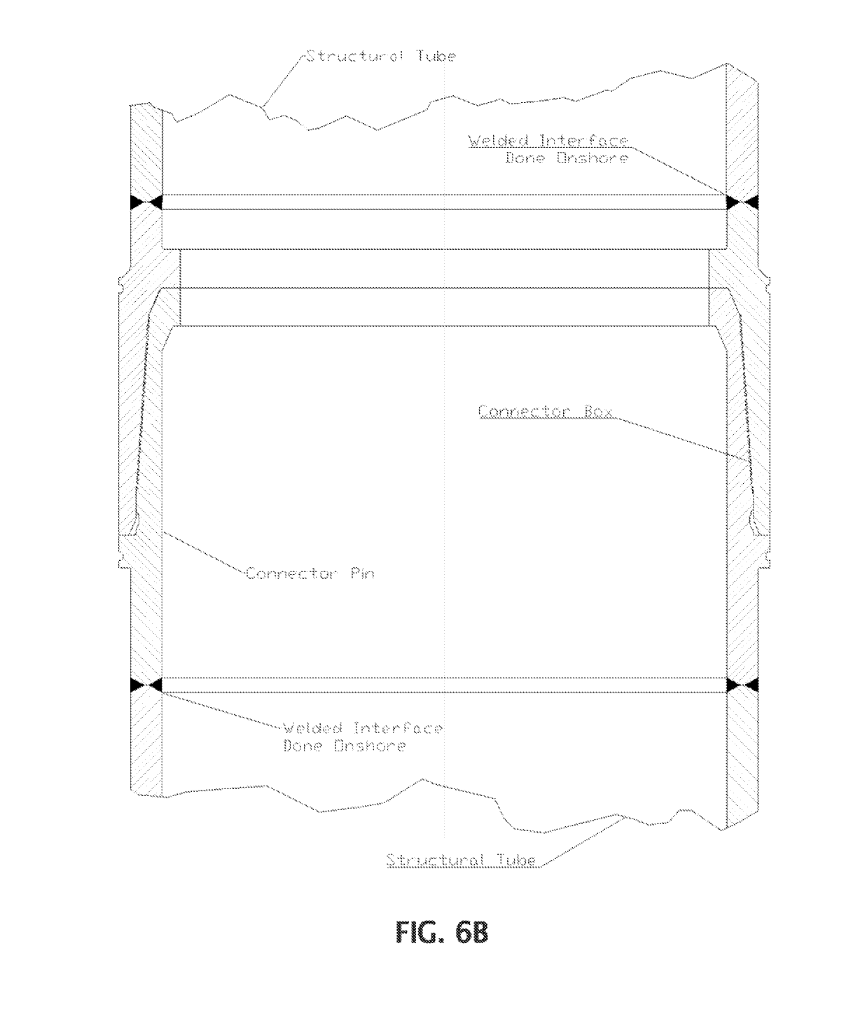

FIGS. 6A and 6B depict an additional embodiment of the present connectors 100a. In this embodiment, connector 100a is a permanent (non-reversible) connector that is not configured to be disconnected once pin component 102a and box component 104a are mated. Stated another way, connector 100a is designed as a snap together interface element which, once made-up, cannot be taken apart, except by cutting. As with connector 100, connector 100a includes a pin component 102a and a box component 104a, both with machined parallel concentric teeth 108, 110 designed to interlock upon full insertion of the pin component into the box component. The teeth (e.g., at least pin teeth 108) can be coated with heavy marine grease prior to make-up. The outer shell of box component 104a is flexible enough to allow the expansion necessary for the teeth to move down the pin. The teeth are designed to slide over one another until they reach the make-up position in which pin component 102a is fully seated in box component 104a. However, teeth 108, 110 are spaced so that they cannot fully interlock until the pin component is fully inserted into the box component (FIG. 6B).

The make-up process begins with the pin component pointed upward, as shown, and the box component pointed down, as shown, and descending down over the pin. The conical arrangement of the teeth makes the pin and box component self-centering. In those instances where the weight of a top side module being connected to the supporting structure is substantial, the weight of the module itself may be sufficient to force make-up of the connector (FIG. 6B). If the module being connected does not possess enough self-weight to force a clean make-up, then a make-break tool (powered by an HPU) must be employed. Grooves 140 are provided in the OD surfaces of both the pin and the box to interface with the circular arms of the tool. Connector 100a is non-reversible because it omits pressure port 136 and indentations 124 and 126 that provide annulus gap 128 and annulus gap 130 disposed between the outer wall of the pin component and the inner wall of the box component of connector 100 (FIGS. 1A-1B). As such, connector 100a does not include a mechanism for pressurizing the box element to expand it relative to the pin component for disassembly.

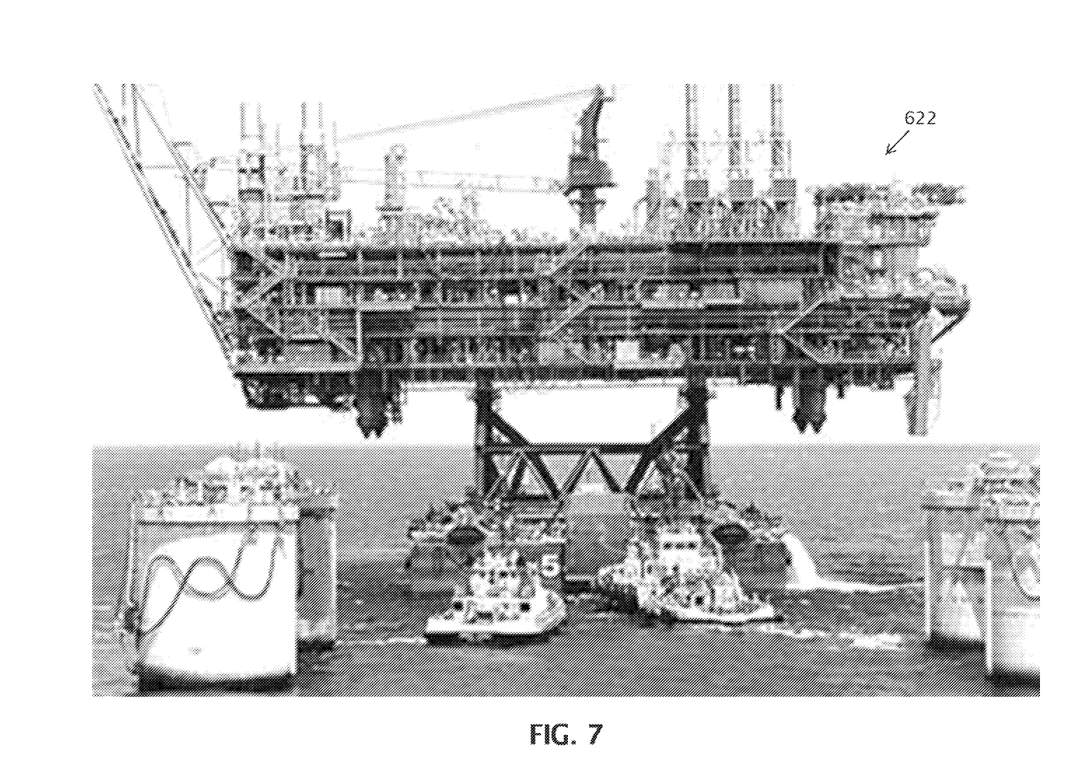

FIG. 7 depicts a float-over installation of a top side module 622 to a supporting structure (whether floating or fixed), for which the present structural connectors (100, 100a) may be used in similar fashion to the uses described above for crane installations. The growing weight and size of top side modules being installed on fixed and floating platforms often exceeds the lifting limits of existing offshore crane technology. This has led to the development of installation by float-over process. Simply described, the process requires a top side package or module 622 to be floated over the top of the platform base, precisely aligned in preparation for mating, and then brought into close proximity with the base (via change in buoyancy) for connection, as illustrated in FIG. 7. These operations can be very complex due to the dynamic environment arising between multiple floaters with a very large and heavy structural package being transferred from one to the other or with a single floater transferring such a load to a fixed base. This dynamic environment can result in impact loads on the various components.

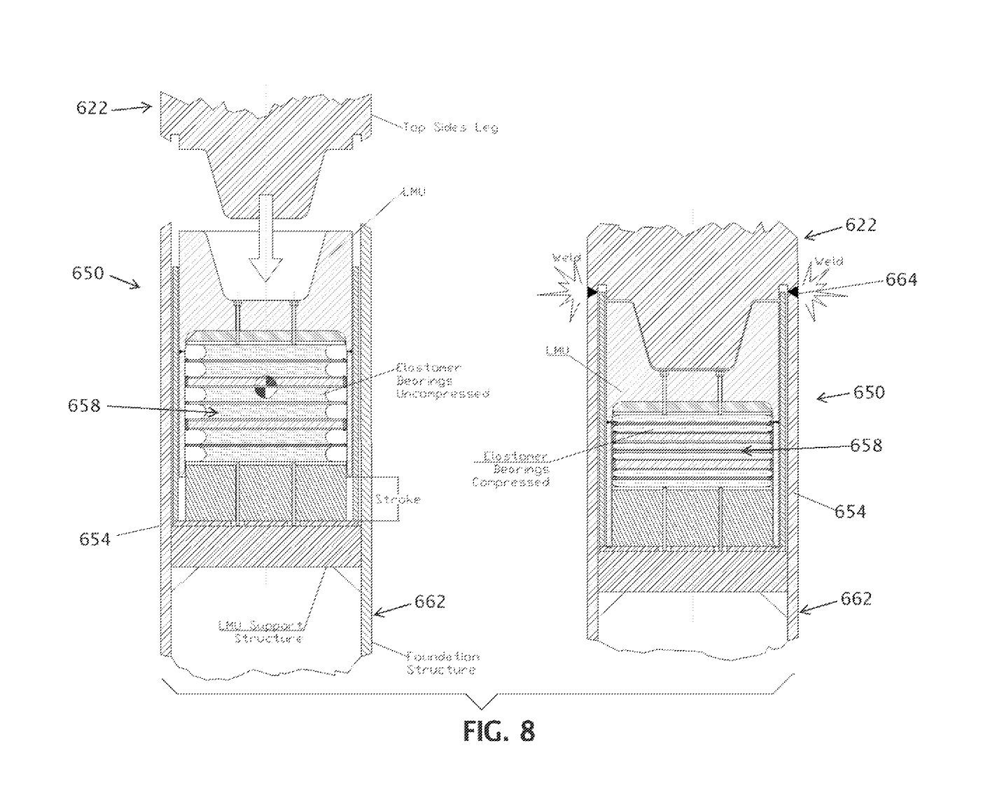

As illustrated in FIG. 8, mitigation of the impact loads as top side package or module 622 is lowered onto the base structure (or the floating target increases its buoyancy to rise to meet the top side module) is normally accomplished with LMUs (Leg Mating Units) and DMUs (Deck Mating Units) 650 that comprise large canisters 654 loaded with elastomeric bearing pads 658 Flat elastomeric bearings 658 inside canisters 654 absorb impacts caused by the vertical heaving between the top side module 622 and the target supporting or foundation structure 662. They also compress as the full load of the top sides package is transferred to the elastomer stack. This compression process allows the legs of the top sides package to gradually come into contact with the legs on the foundation structure. Once the full load of the package is transferred to the base structure and an accurate metal to metal interface is confirmed at all locations, the interfaces have to be held in place and welded out at seams 664.

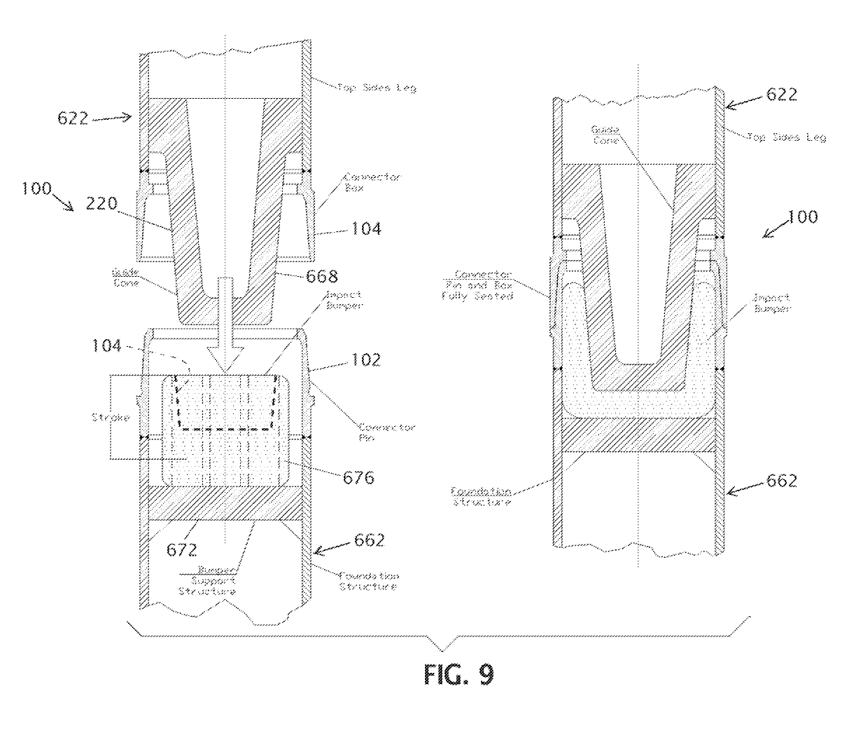

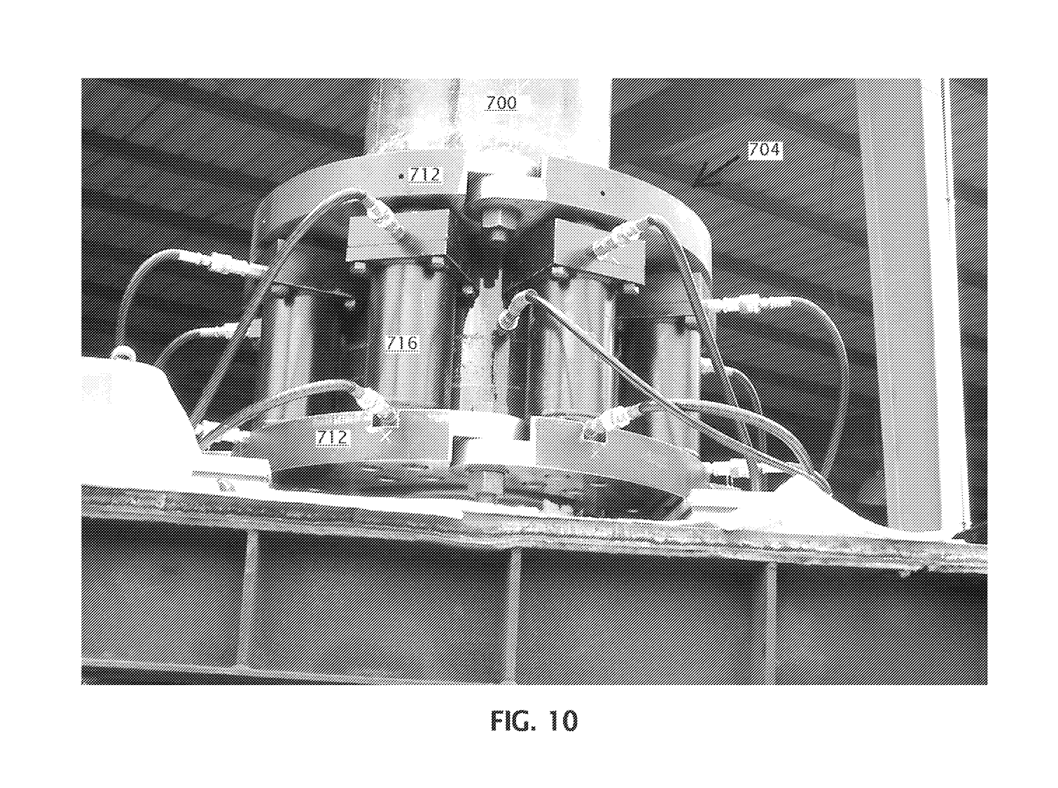

In contrast, however, embodiments of the present connectors (100, 100a) can be used to mating top side module 622 and supporting structure 662 without off-shore welding. For example, FIG. 9 depicts a connector 100 mating a top side module 622 to a supporting structure 662. In the embodiment shown, pin component 102 is welded (e.g., on-shore) to the foundation structure, and box component 104 is welded (e.g., on-shore) to the top side module. In this embodiment, a guide pin 220 is disposed in the tubular to which box component 104 is welded, such that a tapered, conical lower portion 668 extends past a lower end of box component 104 such that tapered lower portion 668 can extend into pin component 102 to self-center the box component relative to the pin component. In this embodiment, a shelf 672 extends across the tubular of the foundation structure 662 to which pin component is coupled. As shown, shelf 672 can carry otherwise support an elastomeric bumper 676 (which can be simpler than LMU or DMU 650 and bearings 658. For example, bumper 676 can include a single, cylindrical elastomeric member and/or can include a tapered, vertical center opening 680 that further contributes to the self-centering function of the depicted embodiment. Bumper 676 need not include any metal components, and may be as simple as a collapsing-column type bumper that can be manufactured by pouring polyurethane into a simple mold. In such embodiments, no press or expensive mold tooling is required to form bumper 676. This relatively simple embodiment of bumper 676 is thus able to absorb the impact loads by resorting to bulk modulus loading as it displaces around the downward descending cone of guide pin 220 and bulks up against the ID of the walls of pin component 102 confining it, as shown. As such, the depicted embodiment can eliminate the need for off-shore welding (weld out), eliminate the need for large and complex LMUs and DMUs, and assure automatic capture and mating of top side module 622 at the precise elevation called for by the structural design.

Like the LMUs and the DMUs described with reference to FIG. 8, at least some embodiments of the present connectors (100, 100a) can require semi-precise vertical and lateral alignment. As the number of such connectors being simultaneously being made-up increases (especially for 4 to 8 being made-up simultaneously), alignment can become of critical concern. The present connectors are designed to accept up to 5 degrees angular misalignment during make-up and break-out without binding or hanging up. In the depicted embodiment, guide pin 220 can help reduce misalignment. Notably, in the depicted embodiment, guide pin 220 and shelf 672 substantially prevent fluid flow through connector 100, such that a liquid-tight connection may not always be as critical as for riser pipers and the like, and some scoring or other damage due to misalignment during make-up may be tolerated in certain instances. Ideally, however, top side module 622 and supporting structure 662 are both level and/or parallel to each other (e.g., within 5 degrees) during mating for all of multiple connectors to make-up simultaneously.

In the present embodiments, top side modules and components can be coupled to supporting structures by one or by multiple ones of the present connectors. For example, embodiments of the present connectors (100, 100a) can have outer diameters (ODs) equal to any one of, or between any two of: 12 inches, 18 inches, 24 inches, 30 inches, 36 inches, 48 inches, 60 inches, 72 inches, or more. For example, FIG. 6A depicts certain dimensions for one example of a connector 100 having a diameter of 60 inches, as shown.

An additional benefit of the use of connector 100, is that connector 100 can be separated without cutting or otherwise damaging the top side module or the foundation structure. In many situations it may be desirable to facilitate removal of the top side module from the platform after a period of use. In such instances, (reversible) connector 100 can be used, as it can be separated or disconnected through the application of pressure via pressure port 136 to annulus 128 and annulus 132 between the box component and the pin component.

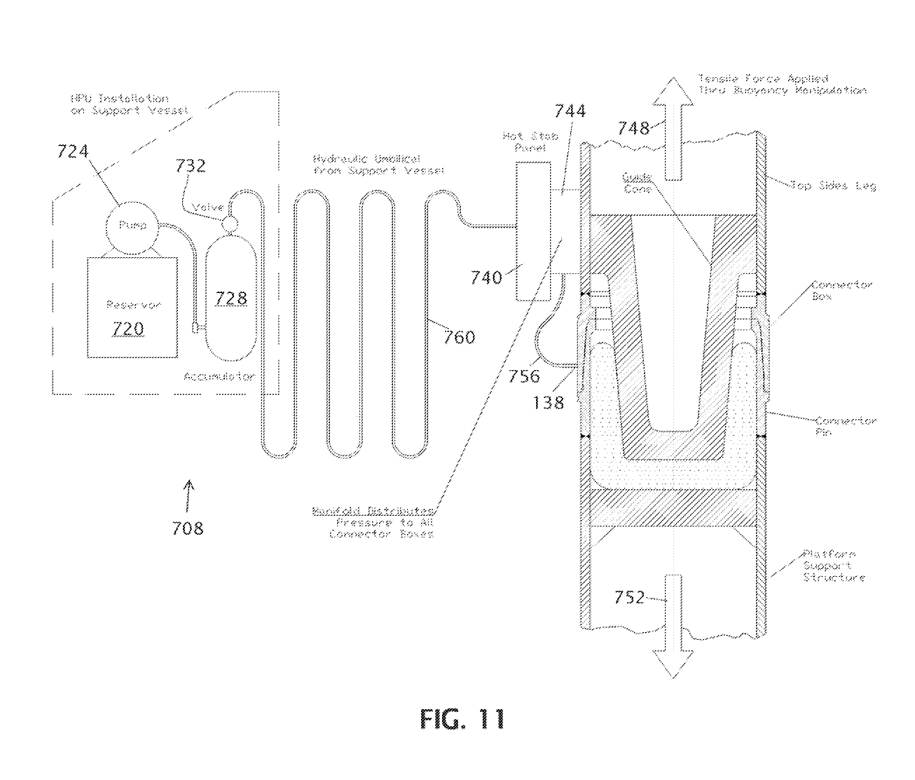

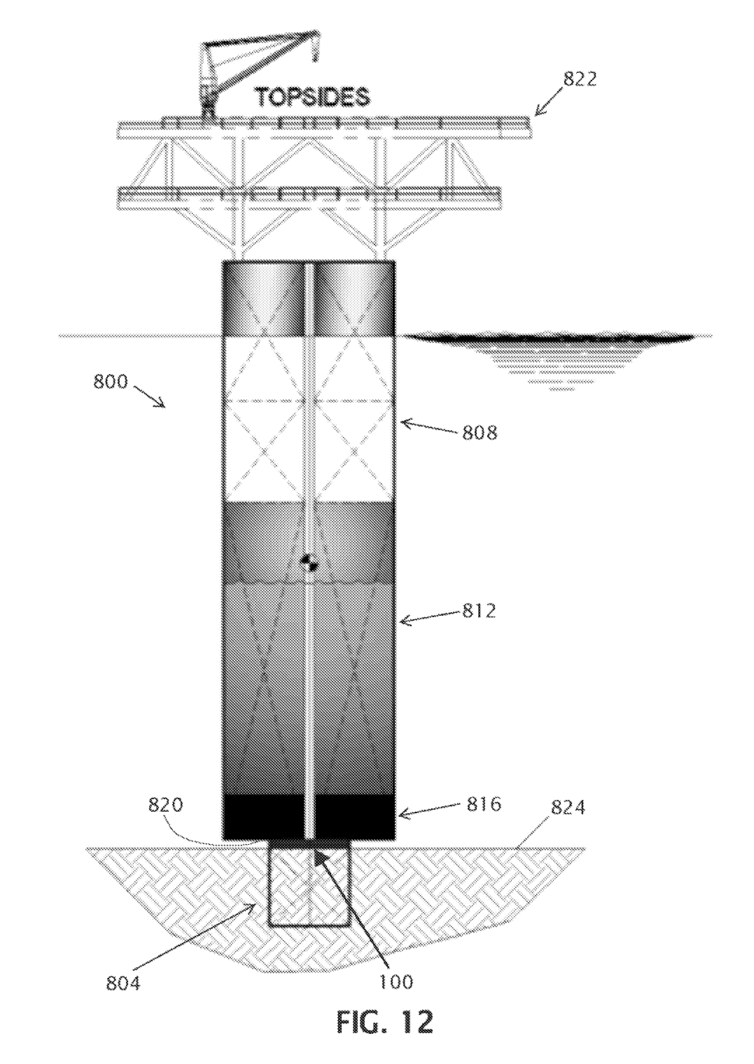

Embodiments of the present connectors (100, 100a) can also be used to install couple peripheral packages 700 to platforms. However, given that such peripheral packages 700 are generally much smaller dimensionally and often have a much lower weight than top side packages and deck modules, peripheral packages are almost always installed using a crane on an adjacent vessel or from a crane on the platform itself. In many instances, the weight of such packages will not possess enough self-weight to complete make-up of the connector without assistance from an external device 704 applying an axial compression load to pin component 102 and box component 104 (via grooves 140). Such a device 704 may be referred to as a “make-break tool” or a “running tool.” An example of a make-break tool 704 and a corresponding hydraulic power unit (HPU) 708 is shown in FIGS. 11 and 12. In this embodiment, tool 704 includes circular arms 712 designed to interface with grooves 140 in the OD of the connector pin and box components, and a plurality of hydraulic cylinders 716 coupled to the upper and lower arms 712. In this embodiment, actuation of hydraulic cylinders 716 can draw arms 712 together and corresponding forces transferred to the pin and box components of the connector via grooves 140. Hydraulic cylinders 716 are controlled by HPU system 708 that includes a reservoir 720, pump 724, accumulators 728, valves 732, and controls for actuation of cylinders 716.

HPU 708 can also provide internal hydraulic pressure to the connector via pressure port 136, when needed for break-out operations. For example, HPU 708 can be coupled to tool 704 and pressure port 136 via a hot-stab panel 740 and manifold 744 (especially for break-out) that simultaneously distributes hydraulic pressure to the connector and to cylinders 716 to pressurize connector and apply a simultaneous axial separation force (e.g., in addition to a buoyant axial separation force that may be generated by increasing buoyancy during float-over separation methodologies).

Generally, disconnection of reversible connector 100 requires two events to happen essentially at the same time: (1) application of an axial tensile load (indicated by arrows 748 and 752 in FIG. 11) tending to pull the pin and box components apart; and (2) application of an internal pressure to annulus 128 and annulus 130 between the pin and box components to separate their respective teeth. In those instances where break-out and removal of a top sides module is likely to be required in the future, and prior to deployment of the top sides module to the installation site and installation on the supporting structure, all of connectors 100 can be plumbed (via pressure ports 136) for simultaneous application of hydraulic pressure between their respective pin and box components. This can be facilitated by installing a hot stab 740 panel (e.g., at or near the bottom of the top sides module, such as, for example, at the same level as the connector box units). As indicated in FIG. 11, hot-stab panel 740 can be plumbed with hydraulic tubing 756 to pressure ports 136 on all of the connector box components. Thus, a hydraulic “umbilical” tube 760 from an HPU 708 on an adjacent vessel, plugged into panel 740, can then be employed to simultaneously apply pressure to the connector annuli as required.

For separation of a top side module from a fixed platform, upward tensile load must be applied to the connection points (e.g., to the entire top side module). This can be done by floating a vessel (e.g., a barge) under the top sides structure (as is depicted in FIG. 7 for an installation) and then decrease the ballast (increase the buoyancy) of the vessel to push up on the top side module. Once a uniform upward force of sufficient magnitude to assist separation has been developed, HPU 708 can be pressurized to a nominal value to confirm that the plumbing and the connectors are holding pressure. The full annular break-out pressure can then be applied simultaneously to all connectors 100 in a sudden fashion (generally not gradually). For example, one or more accumulators 728 can store the pressure for connectors 100, and that pressure then rapidly released into the respective connector annuli via hydraulic “umbilical” tubing 760 to hot stab panel 740 and distributed to each connector via manifold 744. The sudden onset of the annular pressure combined with vertical tension applied via the buoyancy of the vessel will separate the connector pin and box components. As will be appreciated by those of ordinary skill in the art, the build-up of pressure in accumulator(s) 728 and the sudden release of pressure to the connector annuli can be initiated from a control panel on or remote from the HPU 708.

Separation of a top side module from a floating platform can be facilitated by locating a floating vessel under the top sides structure and increasing the ballast (decreasing the buoyancy) of the platform while the ballast of the floating vessel is held constant or decreased to increase the buoyancy of the vessel. This procedure will also result in an upward force on the top side structure. As described above, prior to pushing upward on the top sides module, all of the connectors must be plumbed for simultaneous application of hydraulic pressure to the annulus between the pin and box teeth. Once a uniform upward force of sufficient magnitude to cause separation has been applied, the annular pressure can be applied simultaneously and as rapidly as possible to all the connectors to effect simultaneous separation of the connectors.

FIG. 12 depicts another example of a use of the present structural connectors (100, 100a) coupling a buoyant tower 800 to a semi-permanent base or foundation 804. In the embodiment shown, tower 800 includes a buoyant section 808, a variable ballast section 812, and a fixed ballast section 816. In this embodiment, variable ballast section 812 may be filled with water or the like after tower 800 has been transported (e.g., horizontally on a barge or other vessel) to an installation site. In this embodiment, a lower end 820 of tower 800 carries box component 104 of connector 100 (e.g., and guide pin 220, as illustrated in FIG. 9), and foundation 804 carries pin section 102 of connector 100 (e.g., and shelf 672 and bumper 676, as illustrated in FIG. 9). To install tower 800, base or foundation 804 can be disposed in position on seabed 824 with the pin component 102 extending upward. Tower 800 can then be raised to a vertical orientation with box component 104 directed vertically downward. Tower 800 can then be lowered (e.g., by pumping or otherwise filling chambers in variable ballast section 812 with sea water) until guide pin 220 extends into pin component 102, and box component 104 extends over and fully seats on pin component 102, to secure tower 800 relative to base or foundation 804. Additionally, and as described above, the present connectors 100, 100a can also couple top sides module 822 to the upper end (828) of tower 800.

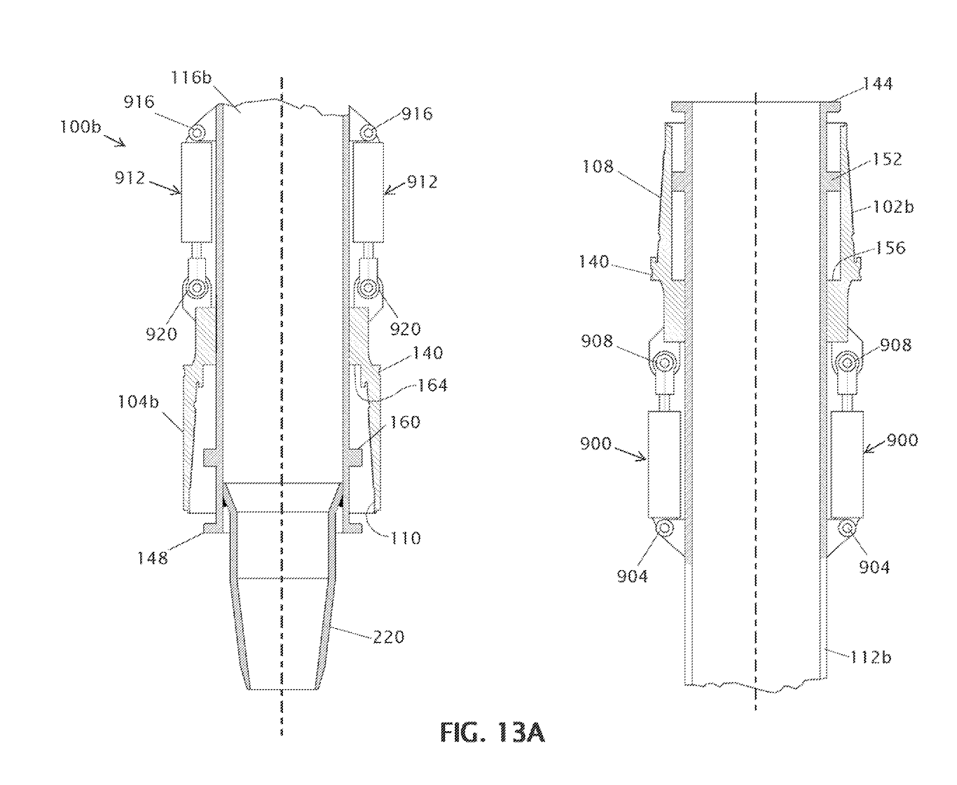

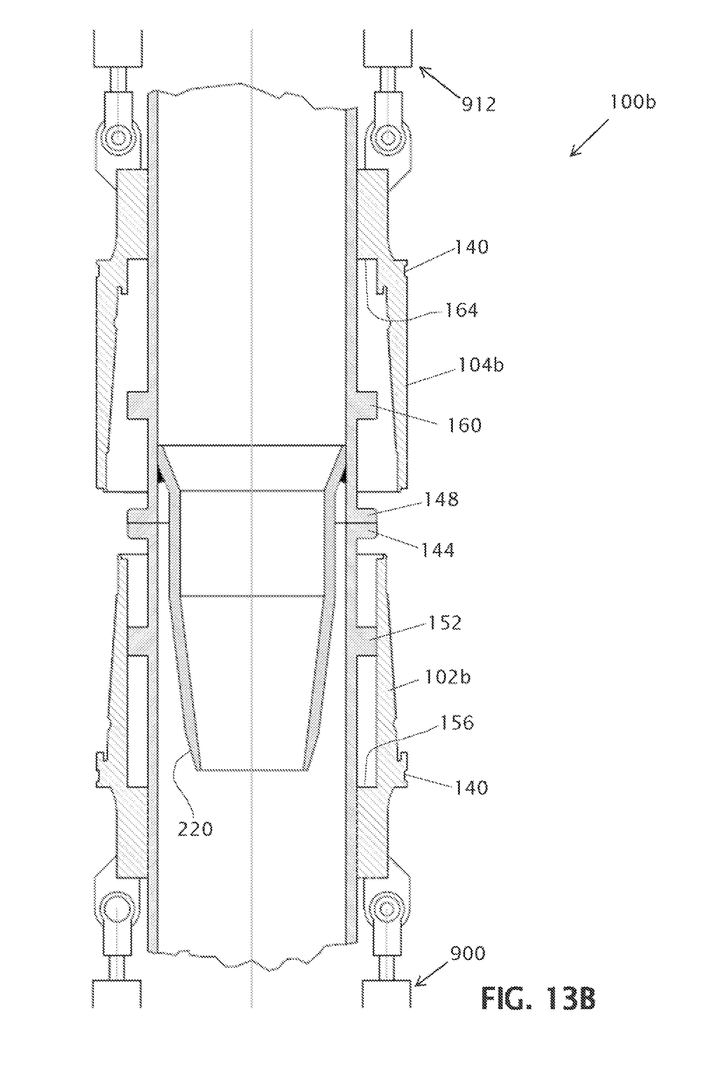

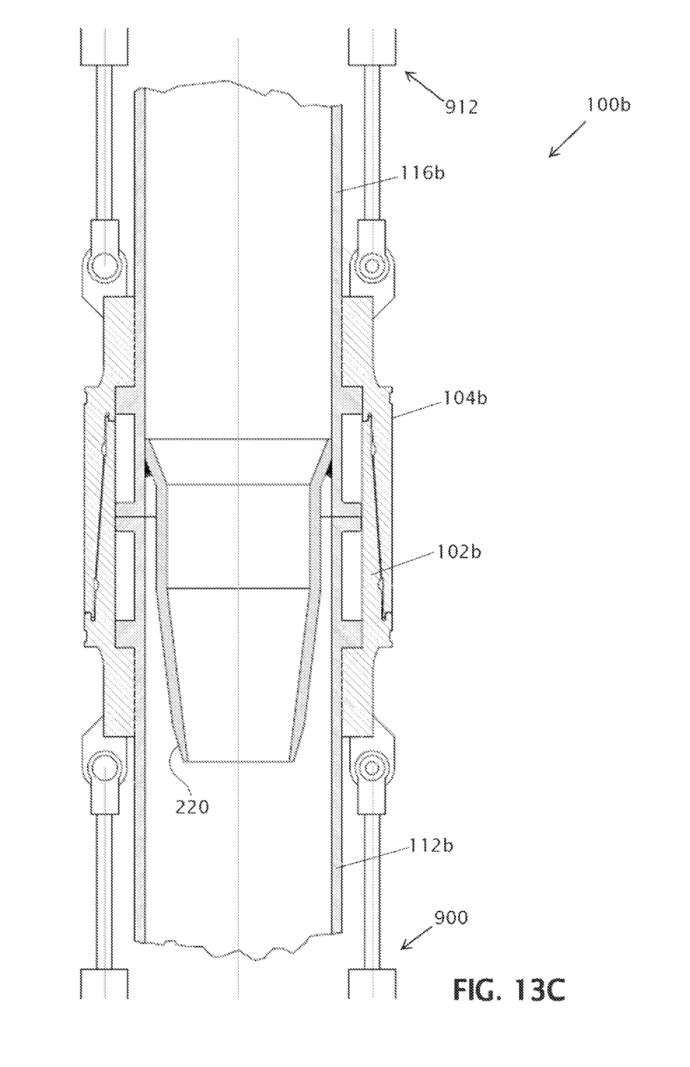

FIGS. 13A-13B depict side cross-sectional views of the components of a third embodiment 100b of the present connectors. More particularly, FIG. 13A depicts connector 100b in a separated configuration; FIG. 13B depicts connector 100b in an intermediate configuration; and FIG. 13C depicts connector 100b in an assembled configuration. In the embodiment shown, connector 100b comprises a pin component 102b that may be similar to pin component 102 or 102a, and a box component 104b that may be similar to box component 104 or 104a. However, unlike in connectors 100 and 100a, in this embodiment, pin component 102b is slidably mounted on a structural member 112b, and box component 104b is slidably mounted on a structural member 116b. In the embodiment shown, structural component 112b includes an abutment flange 144 that is configured to abut an abutment flange 148 of structural component 116b, and structural component 116b includes a guide pin 220 having a tapered exterior surface pin configured to extend into the hollow interior region of structural member 112b (and pin component 102b, as shown in FIG. 13B) to center structural member 116b (and box component 104b) relative to structural member 112b (and pin component 102b). In this embodiment, each structural member 112b, 116b comprises a tubular member that can be welded or otherwise affixed to the various structures described above (e.g., module, tower, platform, topside module, peripheral module, supporting structure, buoyant tower, foundation or base, and/or the like).

In the embodiment shown, structural member 112b includes a limit flange 152 disposed between abutment flange 144 and pin component 102b, with limit flange 152 configured to contact an internal shoulder 156 of pin member 102b to limit travel of the pin member. Similarly, in the embodiment shown, structural member 116b includes a limit flange 160 between abutment flange 148 and box component 104b, with limit flange 160 configured to contact an internal shoulder 164 of box component 104b to limit travel of the box component. In the embodiment shown, connector 100b further includes a plurality of hydraulic cylinders configured to slide the pin and box components together for mating of their respective teeth 108, 110. More particularly, a first plurality of hydraulic cylinders 900 each has a first end 904 coupled to structural member 112b and a second end 908 coupled to pin component 102b such that cylinders 900 can be actuated to press pin component 102b toward abutment flange 144 to mate with box component 104b (or to pull pin component 102b away from abutment flange 144 during break out of connector 100b, as described above for other embodiments of the present connectors. Similarly, a second plurality of hydraulic cylinders 912 each has a first end 916 coupled to structural member 116b and a second end 920 coupled to box component 104b such that cylinders 912 can be actuated to press box component 104b toward abutment flange 148 to mate with pin component 102b (or to pull box component 104b away from abutment flange 148 during break out of connector 100b, as described above for other embodiments of the present connectors. Cylinders 900, 916 can, for example, be coupled to HPU 708, as described above for tool 704. In other embodiments, cylinders 900, 916 are omitted, and a tool such as tool 708 is coupled to pin component 102b and box component 104b via grooves 140 to mate the pin and box components together.

To mate pin component 102b and box component 104b of connector 100b, guide cone 220 is aligned with and inserted into structural member 112b, and structural member 116b is lowered onto structural member 112b until abutment flanges 144 and 148 contact one another, as illustrated in FIG. 13B. Once abutment flanges 144 and 148 are in contact with one another, cylinders 900 and 912 are simultaneously actuated to drive pin component 102b into box component 104b to mate the two components and closer connector 100b, as shown in FIG. 13C. Once pin component 102b and box component 104b are mated together, cylinders 900 and 912 can be disconnected from HPU 708 as the structural integrity of the connection is provided by the teeth of the respective pin and box components, such that hydraulic pressure is unnecessary.

In other embodiments, pin component 102b can be fixed (not slidable) relative to structural member 112b (similar to pin component 102 of connector 100) or box component 104b can be fixed relative to structural member 116b (similar to box component 104 of connector 100), such that only one of pin component 102b and box component 104b is slidable relative to its respective structural member. In some such embodiments, one set of corresponding cylinders 900 or 912 can also be omitted, further simplifying the construction and reducing cost. In other such embodiments, all of the cylinders are omitted such that the connector is configured to be mated or closed with an external makeup tool (e.g., tool 704) that can engage pin component 102 and box component 104 via grooves 140.

One benefit to the use of connector 100b in lieu of connectors 100 or 100a with modules and other structures that include multiple connectors is that connector 100b can be mated individually instead of simultaneously, reducing the need for precise and simultaneous alignment of all connectors at once. For example, if multiple connectors 100b are used to connect jacket module 210 to foundation module 202 in FIG. 2B, jacket module 210 can be set in place with guide pins 220 of connectors 100b extending into respective structural members 112b (e.g., and pin components 102b), and then connectors 100b can be individually aligned and mated, one at a time. Similarly, connectors 100b can be broken out or disconnected one-at-a-time as well, reducing the hydraulic power that would otherwise be required to break out multiple connectors at once. As such, by way of further example, removal of jacket module 210 from foundation module 202 of FIG. 2B can be simplified with connectors 100b in that each connector 100b can be disconnected individually, and jacket module 210 removed once all of the connectors have been disconnected.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the devices are not intended to be limited to the particular forms disclosed. Rather, they include all modifications and alternatives falling within the scope of the claims, and embodiments other than the one shown may include some or all of the features of the depicted embodiment. For example, components may be omitted or combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A connector system comprising:
a pin component defining a hollow interior region and having a tapered exterior surface with a plurality of teeth;
a box component having a tapered interior surface with a plurality of teeth configured to engage the teeth of the pin component;
a guide pin having a tapered exterior surface projecting beyond a mating end of the box component, the tapered exterior surface of the guide pin configured to extend into the hollow interior region of the pin component to center the box component relative to the pin component.

2. The connector system of claim 1, where at least one of the pin component and the box component is slidably coupled to a structural member such that pin component can be engaged with the box component separately from the guide pin being inserted into the hollow interior region of the box component.

3. The connector system of claim 1, further comprising:
an elastomeric bumper disposed within the box component and configured to deform to permit insertion of the pin component.

4. The connector system of claim 1, further comprising:
a pressurization component configured to pressurize an interface between the exterior surface of the pin component and the interior surface of the box component.

5. The connector system of claim 1, where the pin component is attached to a first modular component and the box component is attached to a second modular component.

6. The connector system of claim 1, where the engagement of the teeth of the pin component to the teeth of the box component attaches the pin component to the box component.

7. The connector system of claim 6, where the pin component and the box component are configured to be separated by pressurization of the external surface of the pin component and the internal surface of the box component.

8. A modular structure for supporting an offshore platform, the structure comprising:
a first module comprising a pin component having a tapered exterior surface with a plurality of teeth;
a second module comprising a box component having a tapered interior surface with a plurality of teeth configured to engage the teeth of the pin component;
where the pin component is configured to engage the box component to attach the first module to the second module without welding the pin component to the box component.

9. The modular structure of claim 8, where at least one of the pin component and the box component is slidably coupled to a structural member such that pin component can be engaged with the box component without movement of the first module relative to the second module.

10. The modular structure of any of claims 8-9, where the pin component defines a hollow interior region, the modular structure further comprising:
a guide pin having a tapered exterior surface projecting beyond a mating end of the box component, the tapered exterior surface of the guide pin configured to extend into the hollow interior region of the pin component to center the box component relative to the pin component.

11. The modular structure of claim 10, further comprising:
a bumper disposed within the box component and configured to deform to permit insertion of the pin component.

12. The modular structure of any of claims 8-11, further comprising:
a pressurization component configured to pressurize an interface between the exterior surface of the pin component and the interior surface of the box component.

13. The modular structure of any of claims 8-12, where the engagement of the teeth of the pin component to the teeth of the box component attaches the pin component to the box component.

14. The modular structure of claim 13, where the pin component and the box component are configured to be separated by pressurization of the external surface of the pin component and the internal surface of the box component.

15. The modular structure of any of claims 8-14, where the first module comprises a plurality of the pin components, and the second module comprises a plurality of the box components configured to be simultaneously engaged to the plurality of pin components to attached the first module to the second module.

16. The modular structure of any of claims 8-14, where the first module comprises a plurality of the pin components, and the second module comprises a plurality of the box components configured to be sequentially engaged to the plurality of pin components to attached the first module to the second module.

17. The modular structure of any of claims 8-16, where the first module comprises a foundation structure configured to be coupled to a sea bed; the second module comprises a buoyant tower having an upper end configured to support a topside module or platform, a lower end, and a box component coupled to the lower end, the box component having a tapered interior surface with a plurality of teeth configured to engage the teeth of the pin component; and the pin component is configured to engage the box component to attach the buoyant tower to the foundation structure without welding the pin component to the box component.

18. A method of connecting two structures comprising:
disposing a second module over a first module, where:
the first module comprises a pin component having a tapered exterior surface with a plurality of teeth
the second module comprises a box component having a tapered interior surface with a plurality of teeth configured to engage the teeth of the pin component; and
pressing the pin component and the box component together such that the pin component engages the box component to attach the first module to the second module without welding the pin component to the box component.

19. The method of claim 18, where at least one of the pin component and the box component is slidably coupled to a structural member such that pin component can be engaged with the box component without movement of the first module relative to the second module.

20. The method of any of claims 18-19, where the pin component defines a hollow interior region, and a guide pin having a tapered exterior surface projecting beyond a mating end of the box component, the tapered exterior surface of the guide pin configured to extend into the hollow interior region of the pin component to center the box component relative to the pin component.

21. The method of claim 20, where a bumper is disposed within the box component and configured to deform to permit insertion of the pin component.

22. The method of claim 18, where the engagement of the teeth of the pin component to the teeth of the box component attaches the pin component to the box component.

23. The method of claim 22, where the pin component and the box component are configured to be separated by pressurization of the external surface of the pin component and the internal surface of the box component.

24. The method of any of claims 18-23, where the first and second modules are pressed together by lowering the second module onto the first module.

25. The method of claim 24, where lowering the second module comprises reducing the buoyancy of a vessel supporting the second module.

26. The method of claim 24, where lowering the second module comprises reducing the buoyancy of the second module.

27. The method of claim 24, where lowering the second module comprises actuating a crane from which the second module is suspended.

28. The method of any of claims 18-23, where the first and second modules are pressed together by increasing the buoyancy of the first module.

29. The method of any of claims 18-23, where the first module comprises a plurality of the pin components, and the second module comprises a plurality of the box components configured to be simultaneously engaged to the plurality of pin components to attached the first module to the second module.

30. The method of any of claims 18-23, where the first module comprises a plurality of the pin components, and the second module comprises a plurality of the box components configured to be sequentially engaged to the plurality of pin components to attached the first module to the second module.

31. The method of claim 30, further comprising:
sequentially engaging each pin component with a corresponding box component.

32. The method of any of claims 18-30, where the first module comprises a foundation structure configured to be coupled to a sea bed; the second module comprises a buoyant tower having an upper end configured to support a topside module or platform, a lower end, and a box component coupled to the lower end, the box component having a tapered interior surface with a plurality of teeth configured to engage the teeth of the pin component; and the pin component is configured to engage the box component to attach the buoyant tower to the foundation structure without welding the pin component to the box component.
